(19) United States
(12) Patent Application Publication
(10) Pub. No.: US 2014/0184368 A1
(43) Pub. Date: Jul. 3, 2014

(54) CORRELATED MAGNETIC SYSTEM AND METHOD

(71) Applicant: Correlated Magnetics Research, LLC., Huntsville, AL (US)

(72) Inventors: Larry W. Fullerton, New Hope, AL (US); Mark D. Roberts, Huntsville, AL (US)

(73) Assignee: Correlated Magnetics Research, LLC., Huntsville, AL (US)

(21) Appl. No.: 14/198,226

(22) Filed: Mar. 5, 2014

Related U.S. Application Data
(63) Continuation-in-part of application No. 14/103,760, filed on Dec. 11, 2013.
Application No. 14/103,760 is a continuation-in-part of application No. 13/779,611, filed on Feb. 27, 2013.
Application No. 14/103,760 is a continuation-in-part of application No. 14/066,426, filed on Oct. 29, 2013.
Application No. 14/066,426 is a continuation of application No. 13/374,074, filed on Dec. 9, 2011, now Pat. No. 8,576,036.
Application No. 14/103,760 is a continuation-in-part of application No. 14/086,924, filed on Nov. 21, 2013.
Application No. 14/086,924 is a continuation-in-part of application No. 14/035,818, filed on Sep. 24, 2013.
Application No. 14/035,818 is a continuation-in-part of application No. 13/959,649, filed on Aug. 5, 2013, now Pat. No. 8,692,637.
Application No. 13/959,649 is a continuation-in-part of application No. 13/759,695, filed on Feb. 5, 2013, now Pat. No. 8,502,630.
Application No. 13/759,695 is a continuation of application No. 13/481,554, filed on May 25, 2012, now Pat. No. 8,368,495.
Application No. 13/481,554 is a continuation-in-part of application No. 13/351,203, filed on Jan. 16, 2012, now Pat. No. 8,314,671.
Application No. 13/351,203 is a continuation of application No. 13/157,975, filed on Jun. 10, 2011, now Pat. No. 8,098,122.
Application No. 13/157,975 is a continuation of application No. 12/952,391, filed on Nov. 23, 2010, now Pat. No. 7,961,069.
Application No. 12/952,391 is a continuation of application No. 12/478,911, filed on Jun. 5, 2009, now Pat. No. 7,843,295.
Application No. 12/478,911 is a continuation of application No. 12/478,950, filed on Jun. 5, 2009, now Pat. No. 7,843,296.
Application No. 12/478,950 is a continuation of application No. 12/478,969, filed on Jun. 5, 2009, now Pat. No. 7,843,297.
Application No. 12/478,969 is a continuation of application No. 12/479,013, filed on Jun. 5, 2009, now Pat. No. 7,839,247.
Application No. 12/478,950 is a continuation-in-part of application No. 12/476,952, filed on Jun. 2, 2009, now Pat. No. 8,179,219.
Application No. 12/952,391 is a continuation-in-part of application No. 12/476,952, filed on Jun. 2, 2009, now Pat. No. 8,179,219.
Application No. 12/478,969 is a continuation-in-part of application No. 12/476,952, filed on Jun. 2, 2009, now Pat. No. 8,179,219.
Application No. 12/479,013 is a continuation-in-part of application No. 12/476,952, filed on Jun. 2, 2009, now Pat. No. 8,179,219.
Application No. 12/476,952 is a continuation-in-part of application No. 12/322,561, filed on Feb. 4, 2009, now Pat. No. 8,115,581.
Application No. 12/322,561 is a continuation-in-part of application No. 12/358,423, filed on Jan. 23, 2009, now Pat. No. 7,868,721.
Application No. 14/103,760 is a continuation-in-part of application No. 13/918,921, filed on Jun. 15, 2013.
Application No. 13/918,921 is a continuation of application No. 13/629,879, filed on Sep. 28, 2012, now Pat. No. 8,514,046.
Application No. 13/629,879 is a continuation of application No. 13/426,909, filed on Mar. 22, 2012, now Pat. No. 8,279,032.
Application No. 13/426,909 is a continuation-in-part of application No. 13/179,759, filed on Jul. 11, 2011, now Pat. No. 8,174,347.
Application No. 14/103,760 is a continuation-in-part of application No. 14/045,756, filed on Oct. 3, 2013.
Application No. 14/045,756 is a continuation-in-part of application No. 13/240,335, filed on Sep. 22, 2011, now Pat. No. 8,648,681.
Application No. 13/240,335 is a continuation-in-part of application No. 12/476,952, filed on Jun. 2, 2009, now Pat. No. 8,179,219.
Application No. 12/476,952 is a continuation-in-part of application No. 12/895,589, filed on Sep. 30, 2010.
Application No. 12/895,589 is a continuation-in-part of application No. 12/885,450, filed on Sep. 18, 2010, now Pat. No. 7,982,568.
Application No. 12/885,450 is a continuation-in-part of application No. 12/476,952, filed on Jun. 2, 2009, now Pat. No. 8,179,219.
Application No. 14/045,756 is a continuation-in-part of application No. 13/246,584, filed on Sep. 27, 2011.
(60) Provisional application No. 61/794,427, filed on Mar. 15, 2013.
(60) Provisional application No. 61/798,233, filed on Mar. 15, 2013.
(60) Provisional application No. 61/798,453, filed on Mar. 15, 2013.
(60) Provisional application No. 61/799,507, filed on Mar. 15, 2013.
(60) Provisional application No. 61/800,377, filed on Mar. 15, 2013.
(60) Provisional application No. 61/735,460, filed on Dec. 10, 2012.
(60) Provisional application No. 61/640,979, filed on May 1, 2012.
(60) Provisional application No. 61/604,376, filed on Feb. 28, 2012.
(60) Provisional application No. 61/459,994, filed on Dec. 22, 2010.
(60) Provisional application No. 61/796,863, filed on Nov. 21, 2012.
(60) Provisional application No. 61/744,342, filed on Sep. 24, 2012.
(60) Provisional application No. 61/744,342, filed on Sep. 24, 2012.
(60) Provisional application No. 61/519,664, filed on May 25, 2011.
(60) Provisional application No. 61/465,810, filed on Mar. 24, 2011.
(60) Provisional application No. 61/744,864, filed on Oct. 4, 2012.
(60) Provisional application No. 61/403,814, filed on Sep. 22, 2010.
(60) Provisional application No. 61/462,715, filed on Feb. 7, 2011.
(60) Provisional application No. 61/277,214, filed on Sep. 22, 2009.
(60) Provisional application No. 61/277,900, filed on Sep. 30, 2009.
(60) Provisional application No. 61/278,767, filed on Oct. 9, 2009.
(60) Provisional application No. 61/279,094, filed on Oct. 16, 2009.
(60) Provisional application No. 61/281,160, filed on Nov. 13, 2009.
(60) Provisional application No. 61/283,780, filed on Dec. 9, 2009.
(60) Provisional application No. 61/284,385, filed on Dec. 17, 2009.
(60) Provisional application No. 61/342,988, filed on Apr. 22, 2010.

(51) Int. Cl. H01F 7/02

(52) U.S. Cl. CPC H01F 7/0242
USPC 335/219

(57) ABSTRACT

An improved magnetic system includes a first magnetic structure comprising a first plurality of magnetic sources having a first polarity pattern, a second magnetic structure comprising a second plurality of magnetic sources having a second polarity pattern and at least one mechanical support structure. The first magnetic structure is movable relative to the second magnetic structure. The first and second magnetic structures are engaged and produce a peak spatial force when in a correlated state where the first and second polarity patterns are aligned. The first and second magnetic structures produce an off peak spatial force when in a decorrelated state where the first and second polarity patterns are misaligned, w off peak spatial force resulting from cancellation of at least one repel force by at least one attract force. The at least one mechanical support structure can be engaged to augment the peak spatial force to secure the first and second magnetic structures and can be disengaged to allow the first and second magnetic structures to be disengaged when said first and second magnetic structures are in a decorrelated state.

### RELATED APPLICATIONS

This application claims the benefit under 35 USC 119(e) of provisional applications 61/794,427, titled “Method for Correcting Bias in Correlated Field Emission Structures”, filed Mar. 15, 2013 by Fullerton et al., 61/798,233, titled “Method for Using Symbols in Coded Field Emission Structures”, filed Mar. 15, 2013 by Roberts et al., 61/798,453, titled “Apparatus and Method for Mechanical Augmentation of Correlated Field Emission Structures”, filed Mar. 15, 2013 by Fullerton, 61/799,507, titled “Apparatus and Method for Constraining Field Emission Structures”, filed Mar. 15, 2013 by Fullerton et al, and 61/800,377, titled “Method for Making and Using Composite Coded Field Emission Structures”, filed Mar. 15, 2013 by Roberts et al.

This application is a continuation-in-part of non-provisional application Ser. No. 14/103,760, titled “An Intelligent Magnetic System”, filed Dec. 11, 2013 by Fullerton et al., which claims the benefit under 35 USC 119(e) of provisional application 61/735,460, titled “An Intelligent Magnetic System”, filed Dec. 10, 2012 by Fullerton et al.; Ser. No. 14/103,760 is a continuation-in-part of non-provisional application Ser. No. 13/779,611, titled “System for Detaching a Magnetic Structure from a Ferromagnetic Material”, filed Feb. 27, 2013 by Fullerton et al., which claims the benefit under 35 USC 119(e) of provisional application 61/640,979, titled “System for Detaching a Magnetic Structure from a Ferromagnetic Material”, filed May 1, 2012 by Fullerton et al. and provisional application 61/604,376, titled “System for Detaching a Magnetic Structure from a Ferromagnetic Material”, filed Feb. 28, 2012 by Fullerton et al.; Ser. No. 14/103,760 is also a continuation-in-part of non-provisional application Ser. No. 14/066,426, titled “System and Method for Affecting Flux of Magnetic Structures”, filed Oct. 29, 2013 by Fullerton et al., which is a continuation of U.S. Pat. No. 8,576,036, issued Nov. 5, 2013, which claims the benefit under 35 USC 119(e) of provisional application 61/459,994, titled “System and Method for Affecting Flux of Magnetic Structures”, filed Dec. 22, 2010 by Fullerton et al.; Ser. No. 14/103,760 is also a continuation-in-part of non-provisional application Ser. No. 14/086,924, titled “System and Method for Positioning a Multi-Pole Magnetic Structure” filed Nov. 21, 2013 by Fullerton et al. which claims the benefit under 35 USC 119(e) of provisional application 61/796,863, titled “System for Determining a Position of a Multi-pole Magnetic Structure”, filed Nov. 21, 2012 by Roberts; Ser. No. 14/086,924 is a continuation-in-part of non-provisional application Ser. No. 14/035,818, titled “Magnetic Structures and Methods for Defining Magnetic Structures Using One-Dimensional Codes” filed Sep. 24, 2013 by Fullerton et al. which claims the benefit under 35 USC 119(e) of provisional application 61/744,342, titled “Magnetic Structures and Methods for Defining Magnetic Structures Using One-Dimensional Codes”, filed Sep. 24, 2012 by Roberts; Ser. No. 14/035,818 is a continuation-in-part of non-provisional application Ser. No. 13/959,649, titled “Magnetic Device Using Non Polarized Magnetic Attraction Elements” filed Aug. 5, 2013 by Richards et al. which claims the benefit under 35 USC 119(e) of provisional application 61/744,342, titled “Magnetic Structures and Methods for Defining Magnetic Structures Using One-Dimensional Codes”, filed Sep. 24, 2012 by Roberts; Ser. No. 13/959,649 is a continuation-in-part of non-provisional application Ser. No. 13/759,695, titled: “System and Method for Defining Magnetic Structures” filed Feb. 5, 2013 by Fullerton et al., which is a continuation of application Ser. No. 13/481,554, titled: “System and Method for Defining Magnetic Structures”, filed May 25, 2012, by Fullerton et al., now U.S. Pat. No. 8,368,495; which is a continuation-in-part of non-provisional application Ser. No. 13/351,203, titled “A Key System For Enabling Operation Of A Device”, filed Jan. 16, 2012, by Fullerton et al., now U.S. Pat. No. 8,314,671; Ser. No. 13/481,554 also claims the benefit under 35 USC 119(e) of provisional application 61/519,664, titled “System and Method for Defining Magnetic Structures”, filed May 25, 2011 by Roberts et al.; Ser. No. 13/351,203 is a continuation of application Ser. No. 13,157,975, titled “Magnetic Attachment System With Low Cross Correlation”, filed Jun. 10, 2011, by Fullerton et al., U.S. Pat. No. 8,098,122, which is a continuation of application Ser. No. 12/952,391, titled: “Magnetic Attachment System”, filed Nov. 23, 2010 by Fullerton et al., now U.S. Pat. No. 7,961,069; which is a continuation of application Ser. No. 12/478,911, titled “Magnetically Attachable and Detachable Panel System” filed Jun. 5, 2009 by Fullerton et al., now U.S. Pat. No. 7,843,295; Ser. No. 12/952,391 is also a continuation of application Ser. No. 12/478,950, titled “Magnetically Attachable and Detachable Panel Method,” filed Jun. 5, 2009 by Fullerton et al., now U.S. Pat. No. 7,843,296; Ser. No. 12/952,391 is also a continuation of application Ser. No. 12/478,969, titled “Coded Magnet Structures for Selective Association of Articles,” filed Jun. 5, 2009 by Fullerton et al., now U.S. Pat. No. 7,843,297; Ser. No. 12/952,391 is also a continuation of application Ser. No. 12/479,013, titled “Magnetic Force Profile System Using Coded Magnet Structures,” filed Jun. 5, 2009 by Fullerton et al., now U.S. Pat. No. 7,839,247; the preceding four applications above are each a continuation-in-part of Non-provisional application Ser. No. 12/476,952 filed Jun. 2, 2009, titled “A Field Emission System and Method”, by Fullerton et al., now U.S. Pat. No. 8,179,219, which is a continuation-in-part of Non-provisional Application Ser. No. 12/322,561, filed Feb. 4, 2009 titled “System and Method for Producing an Electric Pulse”, by Fullerton et al., now U.S. Pat. No. 8,115,581, which is a continuation-in-part of Non-provisional application Ser. No. 12/358,423, filed Jan. 23, 2009 titled “A Field Emission System and Method”, by Fullerton et al., U.S. Pat. No. 7,868,721; Ser. No. 14/103,760 is also a continuation-in-part of U.S. patent application Ser. No. 13/918,921, filed Jun. 15, 2013 titled “Detachable Cover System”, by Fullerton et al., which is a continuation application of U.S. patent application Ser. No. 13/629,879, filed Sep. 28, 2012, now U.S. Pat. No. 8,514,046, which is a continuation of U.S. patent application Ser. No. 13/426,909, filed Mar. 22, 2012, now U.S. Pat. No. 8,279,032, which claims the benefit of U.S. Provisional Application Serial No. 61/465,810 (filed Mar. 24, 2011); Ser. No. 13/426,909 is a continuation-in-part of U.S. Non-provisional patent application Ser. No. 13/179,759 (filed Jul. 11, 2011), now U.S. Pat. No. 8,174,347; Ser. No. 14/103,760 is also a continuation-in-part of U.S. Non-provisional patent application Ser. No. 14/045,756, filed Oct. 3, 2013, which is entitled “System and Method for Tailoring Transition Regions of Magnetic Structures”, which claims the benefit of U.S. Provisional Patent Application No. 61/744,864, filed Oct. 4, 2012, which is entitled “System And Method for Tailoring Polarity Transitions of Magnetic Structures”; Ser. No. 14/045,756 is a continuation-in-part of U.S. Non-provisional patent application Ser. No. 13/240,335, filed Sep. 22, 2011, which is entitled “Magnetic Structure Production”, now U.S. Pat. No. 8,648,681, issued Feb. 11, 2014, which claims the benefit of U.S. Provisional Patent Application No. 61/403,814, filed Sep. 22, 2010 and U.S. Provisional Patent Application No. 61/462,715, filed Feb. 7, 2011, both of which are entitled “System And Method For Producing Magnetic Structures”; Ser. No. 13/240,335 is a continuation-in-part of U.S. Pat. No. 8,179,219, issued May 15, 2012, which is entitled “Field Emission System And Method”; Ser. No. 13/240,335 is also a continuation-in-part of U.S. Non-provisional patent application Ser. No. 12/895,589 (filed Sep. 30, 2010), which is entitled “A System And Method For Energy Generation”, which claims the benefit of Provisional Patent Application Nos. 61/277,214, filed Sep. 22, 2009, 61/277,900, filed Sep. 30, 2009, 61/278,767, filed Oct. 9, 2009, 61/279,094, filed Oct. 16, 2009, 61/281,160, filed Nov. 13, 2009, 61/283,780, filed Dec. 9, 2009, 61/284,385, filed Dec. 17, 2009, and 61/342,988, filed Apr. 22, 2010; Ser. No. 12/895,589 is a continuation-in-part of U.S. Pat. No. 7,982,568, issued Jul. 19, 2011, and U.S. Pat. No. 8,179,219, issued May 15, 2012; Ser. No. 14/045,756 is also a continuation-in-part of U.S. patent application Ser. No. 13/246,584, filed Sep. 27, 2011, which is entitled “System and Method for Producing Stacked Field Emission Structures”.

The contents of the provisional patent applications, the contents of the non-provisional patent applications, and the contents of the issued patents that are identified above are hereby incorporated by reference in their entirety herein.

### FIELD OF THE INVENTION

The present invention relates to correlated magnetic systems and methods and more particularly to spatial force interaction between such structures.

### SUMMARY OF THE INVENTION

An improved magnetic system includes a first magnetic structure comprising a first plurality of magnetic sources having a first polarity pattern, a second magnetic structure comprising a second plurality of magnetic sources having a second polarity pattern, the first magnetic structure being movable relative to the second magnetic structure, the first and second magnetic structures being engaged and producing a peak spatial force when in a correlated state where the first and second polarity patterns are aligned, the first and second magnetic structures producing an off peak spatial force when in a decorrelated state where the first and second polarity patterns are misaligned, the off peak spatial force resulting from cancellation of at least one repel force by at least one attract force, and at least one mechanical support structure which can be engaged to augment the peak spatial force to secure said first and second magnetic structures and which can be disengaged to allow the first and second magnetic structures to be disengaged when the first and second magnetic structures are in a decorrelated state.

The first and second magnetic structures can include linear arrays of magnetic sources.

The first and second magnetic structures can include cyclic arrays of magnetic sources.

The first polarity pattern can be complementary to the second polarity pattern such that the peak spatial force is a peak attract spatial force.

The first polarity pattern can be anti-complementary to the second polarity pattern such that the peak spatial force is a peak repel spatial force.

The magnetic system can be configured such that the first and second magnetic structures must be brought together in a first orientation corresponding to the decorrelated state prior to the at least one mechanical support structure being engaged after which the at least one mechanical support structure can be engaged while said first and second magnetic structures remain in the decorrelated state and then the first magnetic structure can be moved relative to the second magnetic structure to a second orientation corresponding to the correlated state while the at least one mechanical support structure is engaged, where the first and second magnetic structures can be brought together in the first orientation by inserting a tab into a slot, and where the at least one mechanical support structure is engaged by moving the first magnetic structure relative to the second magnetic structure to cause the tab to enter into and become slidably engaged within a channel.

The at least one mechanical support structure may include at least one of a tab, a slot, a channel, a groove, a niche, a screw, a hole, or an aperture.

The at least one mechanical support structure can be configured such that the first and second magnetic structures must be brought together in a first orientation corresponding to the decorrelated state and then the first magnetic structure can be moved relative to the second magnetic structure to a second orientation to achieve the correlated state prior to the at least one mechanical support structure being engaged after which the at least one mechanical support structure can be engaged, where the at least one mechanical support structure can include at least one of a flap, a hinge, a button, a snap, a closure, a fastener, a tab, a knob, or a hook.

The at least one mechanical support structure can be configured such that the first and second magnetic structures must be brought together in a first orientation corresponding to the decorrelated state and then the first magnetic structure can be moved relative to said second magnetic structure to a second orientation to achieve the correlated state while the at least one mechanical support structure is being engaged, where the at least one mechanical support structures comprises at least one of a cotter pin, a loop, a split pin, cotter pin, a button, a snap, a loop, a hook, a tab, a flap, or a bolt.

The magnetic system can be configured such that said peak spatial force produced when said first and second magnetic structures enter into said correlated state causes said at least one mechanical support structure to become engaged, where the at least one mechanical support structure comprises at least one spring and the peak spatial force causes the at least one spring to bend resulting in mechanical engagement of the at least one mechanical support structure.

The magnetic system can be configured such that causing said first and second magnetic structures to decorrelate causes the at least one mechanical support structures to become disengaged, where the at least one mechanical support structure may include at least one spring and the decorrelating of said first and second magnetic structures causes the at least one spring to relax resulting in mechanical disengagement of the at least one mechanical support structure.

The at least one mechanical support structure may include a Zeus locking mechanism, which may include at least one of a block, a slot, a spool, a notch, a lock point, a pin, a lock dog, or a spring.

Under one arrangement, the first and second magnetic structures can be brought together and engaged in an orientation corresponding to the correlated state.

### BRIEF SUMMARY OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1A depicts bias attraction forces between North and South poles of a magnet interfacing with ferromagnetic material.

FIG. 1B depicts the combination of the bias attraction force and the force of attraction between opposite polarity poles.

FIG. 1C depicts the combination of the bias attraction force and the force of repulsion between same polarity poles.

FIG. 2A depicts an exemplary ideal linear correlation function of two complementary Barker 4a coded magnetic structures.

FIG. 2B depicts an exemplary linear correlation function of two complementary Barker 4a coded magnetic structures having been shifted upward as a result of a bias attraction force between the two magnetic structures where the amount of upward shift increases with the ratio of interacting magnetic material.

FIG. 2C depicts an exemplary ideal cyclic correlation function of two complementary Barker 4 coded magnetic structures.

FIG. 2D depicts an exemplary cyclic correlation function of two complementary Barker 4 coded magnetic structures having been shifted upward as a result of a bias attraction force between the two magnetic structures where the amount of upward shift is a constant given the ratio of interacting magnetic material is the same for all relative rotations of the magnetic structures.

FIG. 3A depicts exemplary ideal force versus distance curves for sets of correlated magnetic structures in complementary alignment and in anti-complementary alignment.

FIG. 3B depicts exemplary force versus distance curves for sets of correlated magnetic structures in complementary alignment and in anti-complementary alignment, where the two curves have been shifted upward by the amount of a bias attraction force.

FIG. 4 depicts a block diagram of an exemplary device for producing magnetic field emission structures.

FIG. 5 depicts a flowchart of an exemplary method for correcting for a bias attraction force in correlated magnetic structures.

FIG. 6A depicts an exemplary voltage pattern for producing positive polarity field emission sources and negative polarity field emission sources having the same field strength.

FIG. 6B depicts an exemplary voltage pattern in which a bias adjustment consisting of an upward voltage shift has been applied such that positive polarity field emission sources have a greater amplitude than the negative polarity field emission sources.

FIG. 6C depicts an exemplary bias adjustment where the overall amplitude of the voltage curve is decreased in order to allow for an appropriate voltage shift while avoiding oversaturation of the magnetic material.

FIG. 7 depicts an exemplary embodiment of a set of correlated magnetic structures which include discrete bias adjustment magnetic sources for compensating for a bias attractive force.

FIG. 8 depicts a flowchart of another exemplary method for correcting for a bias attraction force in correlated magnetic structures.

FIG. 9 depicts a top view of an exemplary two-dimensional array of overlapping alternating polarity maxels.

FIG. 10 depicts a top view of another exemplary two-dimensional array in which a portion of the alternating polarity maxels has polarities reversed so that the portion is has a complementary polarity pattern of alternating polarities relative to the remaining portions of the array so as to correspond to a Barker 4a code.

FIG. 11 depicts an exemplary first magnetic field emission structure having maxels which are arranged according to a first polarity pattern and an exemplary second magnetic field emission structure having maxels which are arranged according to a second polarity pattern which is complementary to the first polarity pattern, where the first and second polarity patterns correspond to complementary Barker 4a codes.

FIG. 12 depicts an exemplary magnetic structure comprising overlapping concentric circles of overlapping alternating polarity maxels where one quadrant of the maxels has polarities reversed to produce a complementary symbol such that the overall maxel pattern corresponds to a Barker 4 code.

FIG. 13 depicts a flowchart of an exemplary method for using a set of mechanical support structures to augment a set of correlated magnetic structures.

FIG. 14 depicts an exemplary set of mechanically augmented correlated magnetic structures comprising magnetic sources having a polarity pattern corresponding to a cyclic implementation of a Barker 4 code.

FIG. 15 depicts another exemplary set of mechanically augmented correlated magnetic structures comprising magnetic sources having a polarity pattern corresponding to a linear implementation of a Barker 4 code.

FIG. 16 depicts a flowchart of another exemplary method for using a set of mechanical support structures to augment a set of correlated magnetic structures.

FIG. 17 depicts yet another exemplary set of mechanically augmented correlated magnetic structures.

FIG. 18 depicts a flowchart of yet another exemplary method for using a set of mechanical support structures to augment a set of correlated magnetic structures.

FIGS. 19A and 19B depict still another exemplary set of mechanically augmented correlated magnetic structures.

FIG. 20 depict a further exemplary set of mechanically augmented correlated magnetic structures.

FIGS. 21A and 21B depict an exemplary Zeus locking mechanism.

FIG. 22A depicts an exemplary set of complementary magnetic structures which contain field emission sources that have been arranged according to a desired polarity pattern corresponding to an arbitrary code.

FIG. 22B depicts an exemplary correlation function corresponding to the two complementary magnetic structures of FIG. 22A.

FIG. 22C depicts the exemplary magnetic structures of FIG. 2A being constrained such that the magnetic structures can only occupy alignment positions corresponding to their peak alignment position and two off-peak alignment positions on either side of their peak alignment position.

FIG. 23A depicts an exemplary set of complementary magnetic structures which contain field emission sources arranged according to a polarity pattern corresponding to a cyclic implementation of a Barker 4 code.

FIG. 23B depicts the exemplary magnetic structures of FIG. 23A after they have been constrained to isolate desirable portions of the correlation function of their coding.

FIG. 23C depicts the arrangement shown in FIG. 23B except the second magnetic structure has anti-complementary coding.

FIG. 24A depicts an exemplary Barker 7 coded magnetic structure comprising seven equally sized polarity regions corresponding to the seven code elements of the Barker 7 code.

FIG. 24B depicts another exemplary Barker 7 coded magnetic structure comprising four polarity regions of three different sizes.

FIG. 25A depicts an exemplary two-dimensional magnetic structure made up of three magnetic regions of two different sizes that correspond to a combination of vertical and horizontal Barker 4b codes having a common element.

FIG. 25B depicts subdivision of the two larger sized negative polarity regions into three smaller regions corresponding to the three code elements to which they correspond.

FIG. 26 depicts an exemplary composite magnetic structure which includes three different magnetic sources of two different sizes arranged in a configuration that implements a two dimensional Barker 4b code.

FIG. 27 depicts an exemplary composite magnetic structure which includes four different magnetic sources of two different shapes and sizes arranged in a configuration corresponding to two Barker 4b codes.

FIG. 28 depicts an exemplary composite magnetic structure which contains four different magnetic sources of three different shapes corresponding to a Barker 4b code over a Barker 4b code over a Barker 4a code.

FIG. 29 depicts an exemplary composite magnetic structure which contains two magnetic sources of different shapes which correspond to a cyclic Barker 4 code.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be thorough and complete and will fully convey the scope of the invention to those skilled in the art.

Certain described embodiments may relate, by way of example but not limitation, to systems and/or apparatuses comprising magnetic structures, magnetic and non-magnetic materials, methods for using magnetic structures, magnetic structures produced via magnetic printing, magnetic structures comprising arrays of discrete magnetic elements, combinations thereof, and so forth. Example realizations for such embodiments may be facilitated, at least in part, by the use of an emerging, revolutionary technology that may be termed correlated magnetics. This revolutionary technology referred to herein as correlated magnetics was first fully described and enabled in the co-assigned U.S. Pat. No. 7,800,471 issued on Sep. 21, 2010, and entitled “A Field Emission System and Method”. The contents of this document are hereby incorporated herein by reference. A second generation of a correlated magnetic technology is described and enabled in the co-assigned U.S. Pat. No. 7,868,721 issued on Jan. 11, 2011, and entitled “A Field Emission System and Method”. The contents of this document are hereby incorporated herein by reference. A third generation of a correlated magnetic technology is described and enabled in the co-assigned U.S. Pat. No. 8,179,219, issued May 15, 2012, and entitled “A Field Emission System and Method”. The contents of this document are hereby incorporated herein by reference. Another technology known as correlated inductance, which is related to correlated magnetics, has been described and enabled in the co-assigned U.S. Pat. No. 8,115,581 issued on Feb. 14, 2012, and entitled “A System and Method for Producing an Electric Pulse”. The contents of this document are hereby incorporated by reference.

Material presented herein may relate to and/or be implemented in conjunction with multilevel correlated magnetic systems and methods for producing a multilevel correlated magnetic system such as described in U.S. Pat. No. 7,982,568, issued Jul. 19, 2011 which is all incorporated herein by reference in its entirety. Material presented herein may relate to and/or be implemented in conjunction with energy generation systems and methods such as described in U.S. patent application Ser. No. 13/184,543, filed Jul. 17, 2011, which is all incorporated herein by reference in its entirety. Such systems and methods described in U.S. Pat. No. 7,681,256, issued Mar. 23, 2010, U.S. Pat. No. 7,750,781, issued Jul. 6, 2010, U.S. Pat. No. 7,755,462, issued Jul. 13, 2010, U.S. Pat. No. 7,812,698, issued Oct. 12, 2010, U.S. Pat. Nos. 7,817,002, 7,817,003, 7,817,004, 7,817,005, and 7,817,006, issued Oct. 19, 2010, U.S. Pat. No. 7,821,367, issued Oct. 26, 2010, U.S. Pat. Nos. 7,823,300 and 7,824,083, issued Nov. 2, 2011, U.S. Pat. No. 7,834,729, issued Nov. 16, 2011, U.S. Pat. No. 7,839,247, issued Nov. 23, 2010, U.S. Pat. Nos. 7,843,295, 7,843,296, and 7,843,297, issued Nov. 30, 2010, U.S. Pat. No. 7,893,803, issued Feb. 22, 2011, U.S. Pat. Nos. 7,956,711 and 7,956,712, issued Jun. 7, 2011, U.S. Pat. Nos. 7,958,575, 7,961,068 and 7,961,069, issued Jun. 14, 2011, U.S. Pat. No. 7,963,818, issued Jun. 21, 2011, and U.S. Pat. Nos. 8,015,752 and 8,016,330, issued Sep. 13, 2011, and U.S. Pat. No. 8,035,260, issued Oct. 11, 2011, are all incorporated by reference herein in their entirety.

Material presented herein may relate to and/or be implemented in conjunction with systems and methods described in U.S. Provisional Patent Application 61/640,979, filed May 1, 2012 titled “System for Detaching a Magnetic Structure from a Ferromagnetic Material”, which is incorporated herein by reference. Material may also relate to systems and methods described in U.S. Provisional Patent Application 61/796,253, filed Nov. 5, 2012, titled “System for Controlling Magnetic Flux of a Multi-pole Magnetic Structure”, which is incorporated herein by reference. Material may also relate to systems and methods described in U.S. Provisional Patent Application 61/735,403, filed Dec. 10, 2012, titled “System for Concentrating Magnetic Flux of a Multi-pole Magnetic Structure”, which is incorporated herein by reference.

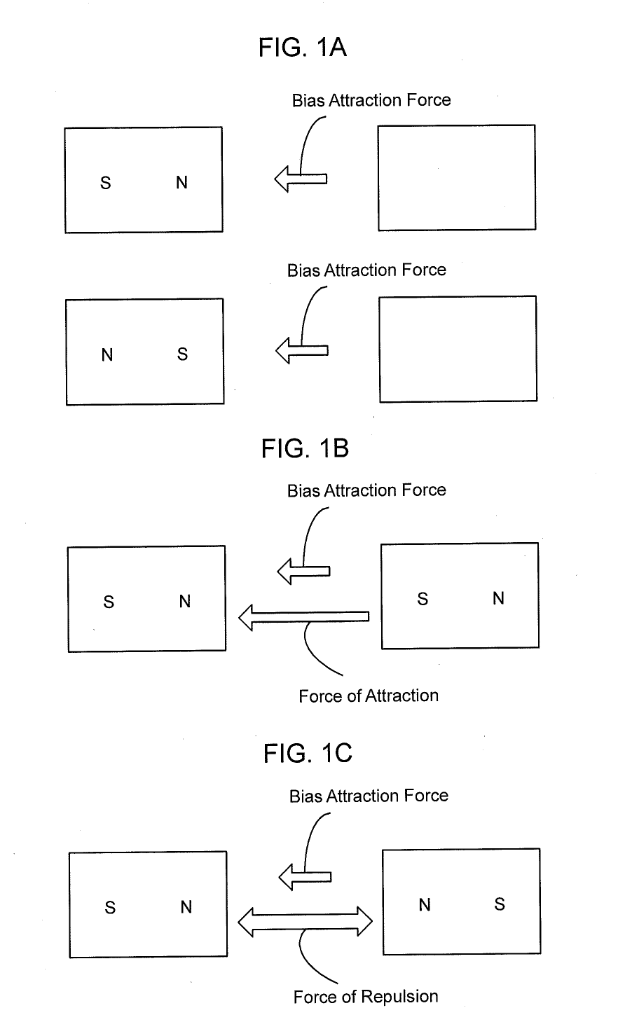

The inventors have determined that a given set or sets of magnetic field emission structures can exhibit a bias attraction force when they are magnetically engaged with each other that can be to a large extent negated, corrected, or otherwise adjusted to affect correlation properties between magnetic field emission structures. FIG. 1A shows a magnetic field emission source having opposing N and S polarities being attracted to a piece of non-magnetized ferromagnetic material when the N pole is in the proximity of the ferromagnetic material. A similar attractive force exists when the S pole is in the proximity of the ferromagnetic material. This inherent attraction tendency of either pole of a magnetic field emission source to be attracted to non-magnetized ferromagnetic material corresponds to a bias attraction force that biases the correlation behavior of correlated magnetic structures. The present invention takes into account the presence of the bias attraction forces in correlated magnetic structures, for example, by correcting for such bias attraction forces so as to overcome the biasing of the correlation behavior between two structures. Such correction could be accomplished by adjusting the magnetic field strength proportionate to the bias attraction force. Such adjustment could be implemented during creation of magnetic field sources on a ferromagnetic material or by the introduction of suitable discrete bias adjustment sources.

FIG. 1B shows the ferromagnetic material of FIG. 1A after it has been magnetized to become a second magnetic field emission source. The bias attraction force interacts with the attraction or repulsion between the two magnetic field emission sources that is due to their magnetization. As a result of this bias attraction force, the overall force of attraction between the two magnetic field emission sources is greater than might be expected purely as a result of their respective magnetic field strengths. FIG. 1C shows the same two magnetic field emission sources arranged so that they repel. Due to the bias attraction force shown above, the overall repulsion force is less than might be expected purely as a result of their respective magnetic field strengths. This same effect can be observed among any number of magnetic field emission sources.

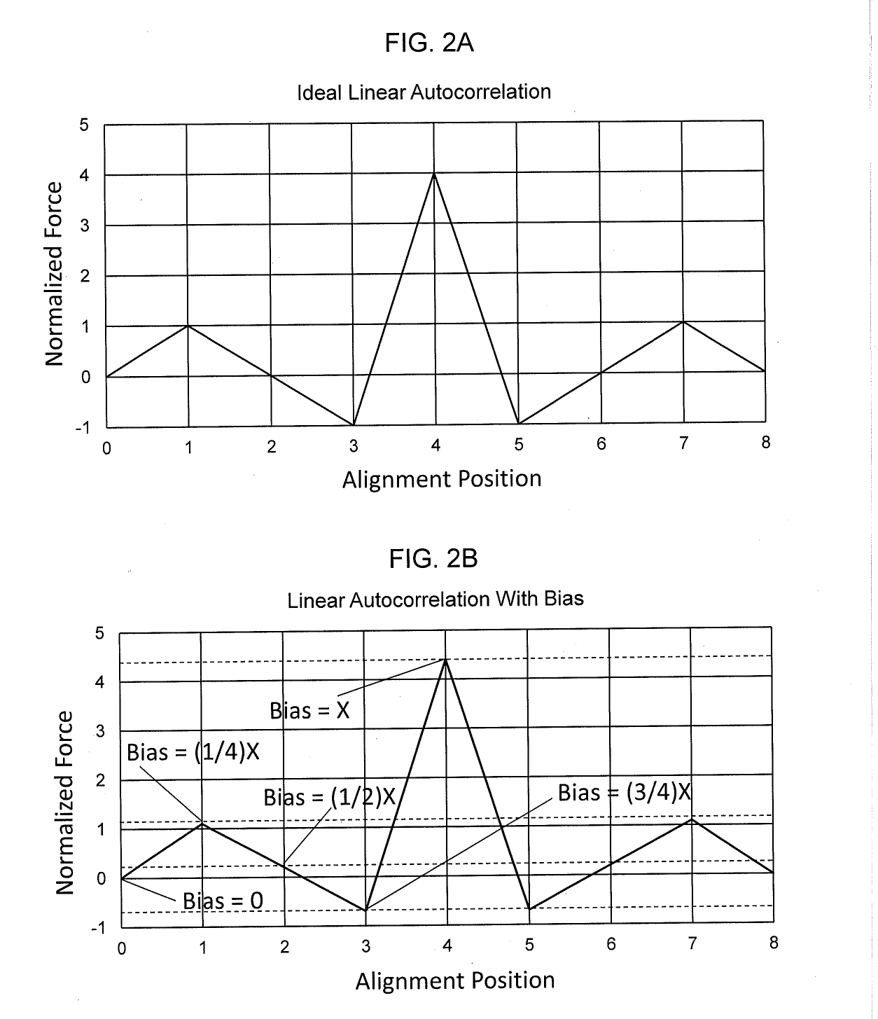

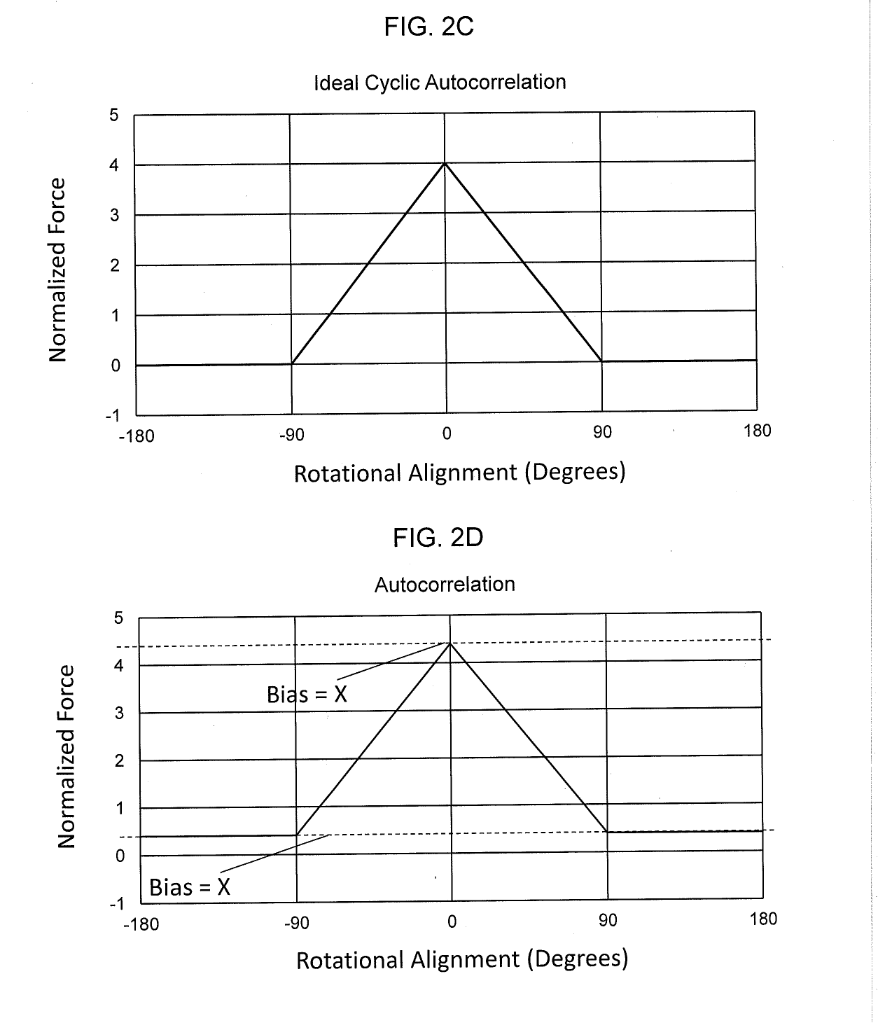

FIG. 2A depicts an ideal linear correlation function for a set of magnetic structures of magnetic sources having polarities in accordance with a Barker 4A code, which is based on the premise that any two interfacing magnetic sources have the same field strength and will therefore produce either a normalized attract force (+1) or a normalized repel force (−1) having the same magnitudes. However, as a result of the bias attraction force discussed above, when these structures are introduced to each other they can have a correlation function as depicted in FIG. 2B that is shifted upward by bias amounts, where the amount of bias for a given alignment position corresponds to the ratio of interacting magnetic material. Specifically, an examplary amount of bias attraction force X is produced when the two magnetic structures are fully aligned (i.e., ratio=1), which decreases to a substantially zero force (when not taking into account side forces) at the two ends of the correlation curve where the ratios of interacting magnetic structures equals zero. For example, if only ¼ of the structures are in alignment then the amount of bias attraction force present for that alignment position is ¼X. In other words, the bias attraction force can be approximated to be a linear function corresponding to the extent that two magnetic field emission sources are aligned.

FIG. 2C depicts an ideal cyclic correlation function for a set of magnetic structures of magnetic sources having polarities in accordance with a Barker 4A code. As a result of the bias attraction force discussed above, these structures can have a correlation function as depicted in FIG. 2D that is shifted upward by a bias attractive force amount, where the bias attractive force amount stays the same regardless of the rotational alignment of the interacting magnetic material which stays the same for each rotational alignment. Specifically, an amount of bias attraction force X is produced when the codes of the two magnetic structures are fully aligned (as represented by zero degrees) but the bias attractive force remains substantially constant for all other rotational alignments.

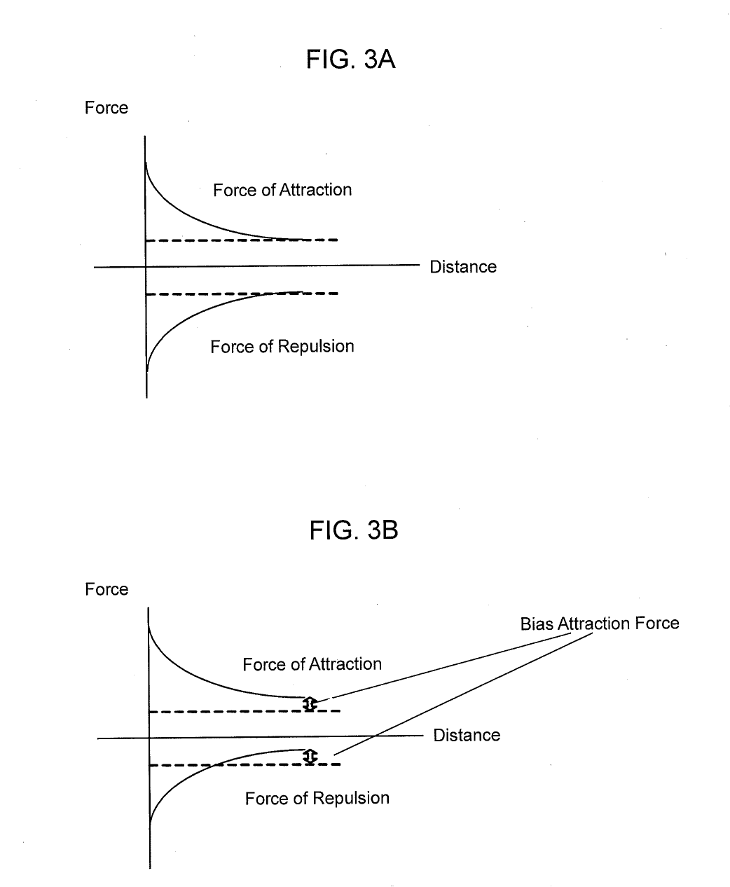

As another example, FIG. 3A shows ideal force versus (separation) distance curves for sets of correlated magnetic structures in complementary alignment (i.e., the top curve) and in anti-complementary alignment (i.e., the bottom curve). With these ideal force versus distance curves, the force of attraction and the force of repulsion are mirror images of each other. However, when the structures are introduced to each other, they can produce the force versus distance curves shown in FIG. 3B for complementary and anti-complementary alignments, in which the magnitude of the force of attraction is increased by a certain bias attraction force, and the magnitude of the force of repulsion is decreased by the same bias attraction force.

In accordance with one aspect of the invention, bias attraction force correction can be achieved by varying the field strengths of individual field emission sources which make up complementary or anti-complementary field emission structures as the field emission structures are being created. Generally, as described in more detail in U.S. Pat. No. 8,179,219, a magnetic field structure can be produced by varying the location of a magnetic material relative to an inductor coil as the magnetizable material is magnetized in accordance with a desired code, where the polarities and the field strengths of the printed magnetic field emission sources of each structure can be controlled.

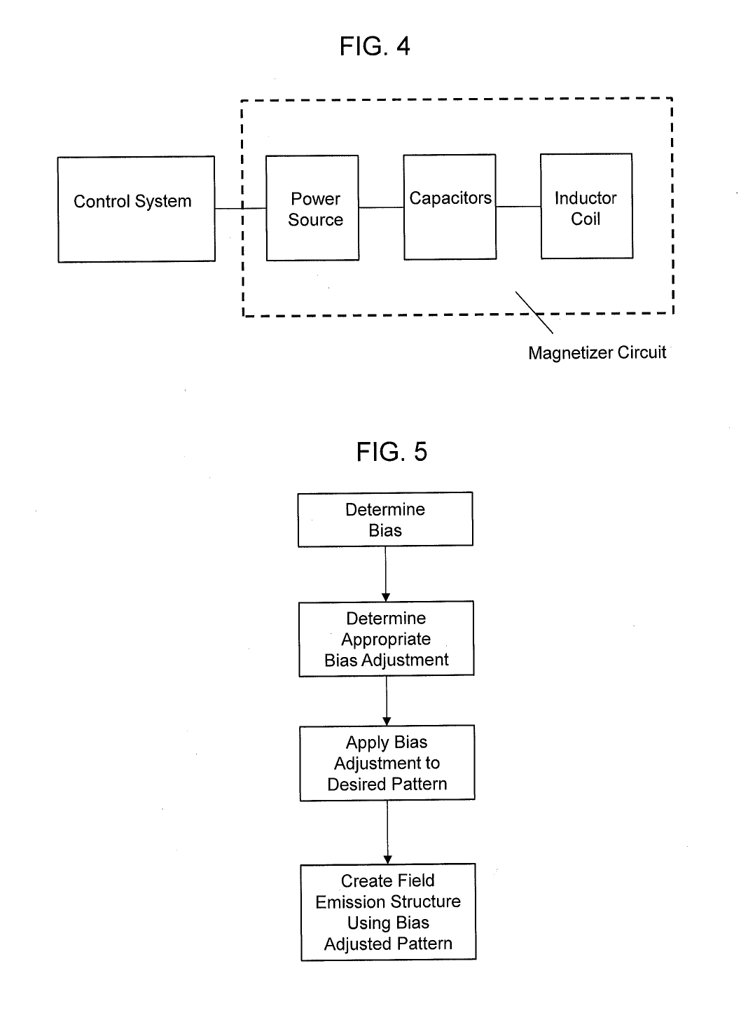

FIG. 4 shows a block diagram of an exemplary device for producing magnetic field emission structures. The device can include a control system connected to a magnetizer circuit. The magnetizer circuit can include power supplies, capacitors, silicon controlled rectifiers, diodes, resistors, and an inductor coil. The control system controls the amount of voltage used to charge a capacitor(s) which determines the amount of current that passes through the inductor coil. By controlling the voltage, the magnitude of the magnetic field produced when printing a magnetic field emission source (or maxel) is controlled, which determines the field strength of the printed maxel. The control system also controls the polarity of each maxel by controlling the direction of the current passing through the coil. The control system also controls the timing of the magnetizing as well as the movement of the material relative to the inductor coil.

By controlling the creation of maxels at different locations on a material, a magnetic structure containing field emission sources can be created where the field emission sources are arranged according to a desired polarity pattern corresponding to a code, for example a Barker 4 code. Generally, the correlation theory that has been taught relating to correlated magnetic structures has been idealized such that the North and South polarity field emission sources having the same field strength have been treated as being equal when normalized. As such, if all field emission sources of given structure are printed using a given constant print voltage (e.g., +/−100v), then the correlation function of complementary magnetic structures having a polarity pattern corresponding to a given code were idealized such that attract forces between opposite polarity field emission sources were treated as being equal to repel forces between same polarity field emission sources.

FIG. 5 depicts a flowchart of a method for correcting for a bias attraction force in correlated magnetic structures according to one aspect of the invention. First, the bias attraction force present in a given set or sets of correlated magnetic field structures can be determined. Next, an appropriate bias adjustment can be determined, and the bias adjustment can be applied to the desired voltage pattern, for example by amplitude modulation. Next, the control system can instruct the voltage source to provide the bias adjusted pattern to the induction coil in order to create the bias adjusted field emission structure.

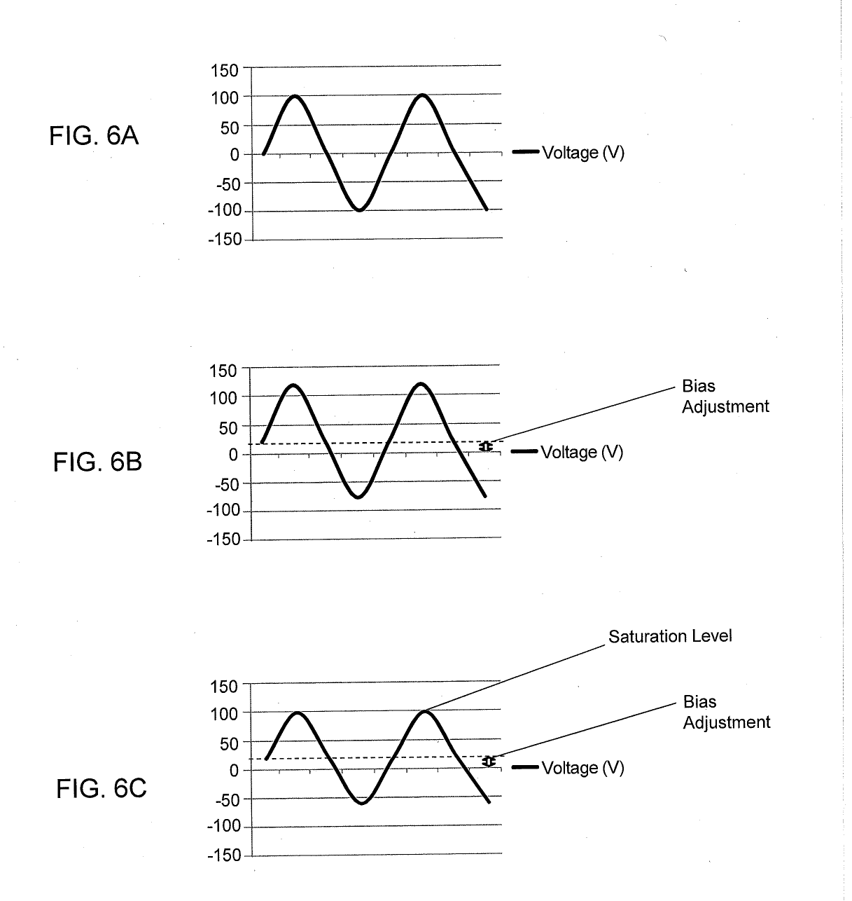

FIG. 6A shows an exemplary voltage pattern for producing positive (i.e., North) polarity field emission sources and negative (i.e., South) polarity field emission sources that will have the same field strength (or amplitude). FIG. 6B shows an exemplary voltage pattern in which a bias adjustment consisting of an upward shift has been applied such that positive polarity field emission sources have a greater amplitude (i.e., field strength) than the negative polarity field emission sources. This approach can be described as providing a positive polarity bias. The same effect can be produced by increasing the negative polarity voltage and decreasing the positive polarity voltage by the same voltage amounts, which can be described as providing a negative polarity bias. In either case, when like positive (or like negative) field emission sources are aligned they will produce a greater repel force than the attract forces that will be produced when opposite polarity field emission sources are aligned. As such, the bias attraction force will have been counteracted by a repelling force bias.

Some magnetic materials have a saturation point at which an increase in applied external magnetic field cannot increase the magnetization of the material further. As a result, applying a bias adjustment of simply shifting a voltage curve as shown in FIG. 6B may not produce the desired result if, for example, the original curve already causes the induction coil to produce a magnetic field close to the saturation point of the magnetic material. In situations such as this, the bias adjustment can instead be chosen, as shown in FIG. 6C, such that the overall amplitude of the voltage curve is decreased in order to allow for an appropriate voltage shift while avoiding oversaturation of the magnetic material.

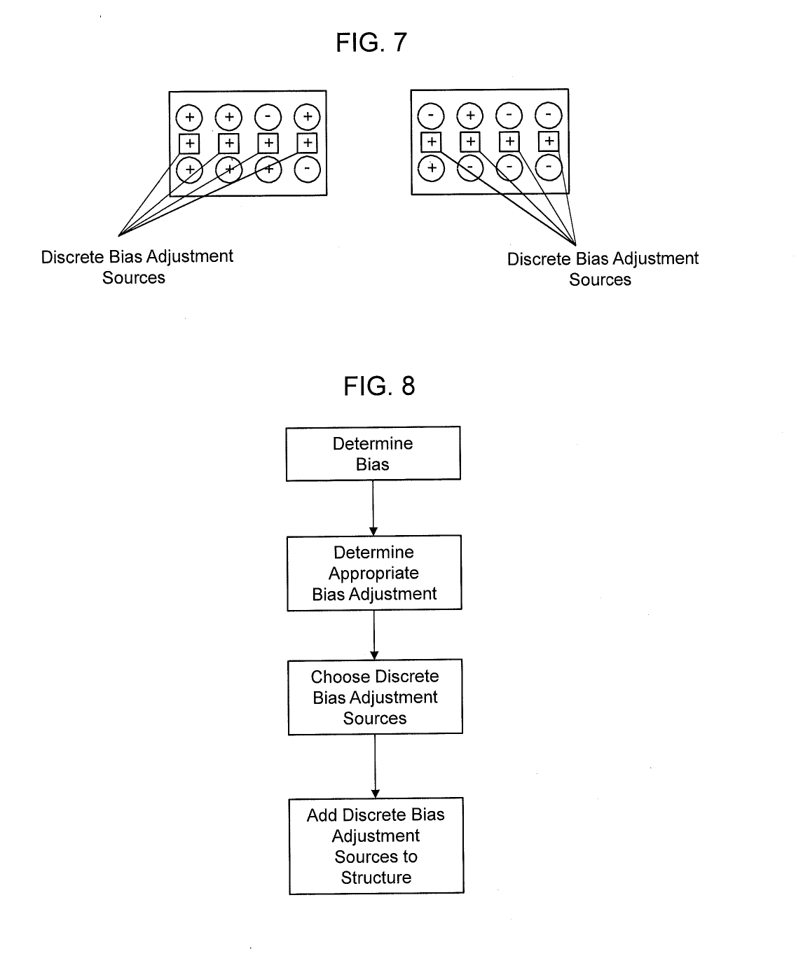

In accordance with another aspect of the invention, bias correction can be achieved by introducing discrete bias adjustment sources. FIG. 7 shows an exemplary embodiment of a set of correlated magnetic structures which have been adjusted to compensate for bias. The set of structures can contain discrete field emission sources arranged in a desired code, for example a Barker 4A code. The set of structures can also contain discrete bias adjustment sources which can be chosen to correct for bias attraction force. As before, the discrete bias adjustment sources can provide a positive polarity bias or a negative polarity bias.

FIG. 8 depicts a flowchart of a method for correcting bias in correlated magnetic structures according to one aspect of the invention. First, the bias present in a given set or sets of correlated magnetic field structures can be determined. Next, an appropriate bias adjustment can be determined, and discrete bias adjustment sources can be chosen to implement the appropriate bias adjustment. Next, these discrete bias adjustment sources can be added to the set of correlated structures.

In the embodiments discussed above, the bias adjustment can be achieved by adjusting the field strength of the positive polarity field emission sources by a certain amount, by adjusting the field strength of the negative polarity field emission sources by a desired amount, or by adjusting the field strength of both the positive polarity and negative polarity field emission sources by desired certain amount. Similarly, bias adjustment can be achieved by adding positive polarity discrete bias adjustment sources, by adding negative polarity discrete adjustment sources, or any combination of the two.

In addition, in situations in which a set of correlated field emission structures contains more than one independent interfacing region, the same adjustment can be applied across the entire set of field emission structures, or different adjustments can be applied to different independent interfacing regions within the set of field emission structures.

For example, in a set of correlated field emission structures which contains two independent interfacing regions, one of the regions can be configured as a Barker 4A code, and the other region can be configured as a Barker 4B code. According to an aspect of the invention, a positive polarity bias adjustment or a negative polarity bias adjustment can be applied to all of the field emission sources within the entire set of structures. According to another aspect of the invention, a positive polarity bias adjustment can be applied to field emission sources in the Barker 4A region, and a negative polarity bias adjustment can be applied to field emission sources in the Barker 4B region, or vice versa. According to other aspects of the invention, any desired adjustment or combination of adjustments can be applied in order to correct for bias attraction forces.

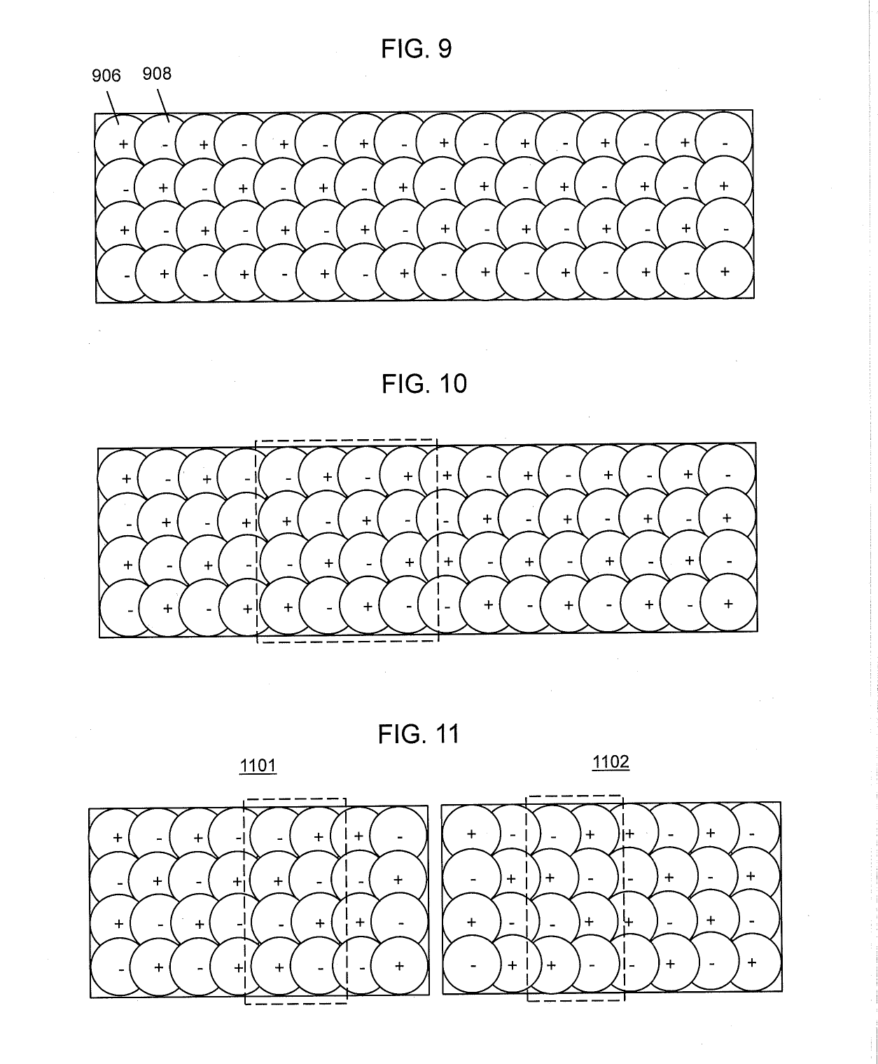

As discussed in U.S. patent application Ser. No. 13/240,335, filed Sep. 22, 2011, entitled “Magnetic Structure Production”, which is hereby incorporated by reference herein, overlapping maxels may be produced by at least partially overwriting at least one maxel with at least one other maxel. FIG. 9 depicts an example top view of an example two-dimensional array of alternating polarity maxels 906 908 that are printed in an example order in rows from left to right and in columns from top to bottom of a magnetizable material. An overlapping of maxels may define or at least partially establish, for example, a maxel density. By way of example but not limitation, a maxel density may be considered a number of maxels printed for a given print area, wherein a maxel spacing may comprise a difference between an approximate center (e.g., a center point, a centroid, etc.) of the printed maxels. As shown for an illustrated example implementation, maxel spacing may be substantially the same for both dimensions (e.g., left-to-right and top-to-bottom); alternatively, they may differ.

For certain example embodiments, a determined maxel size, spacing, and/or density, etc. may be ascertained for a given magnetizable material having a given thickness in order to meet one or more criteria. Examples of criteria may include, but are not limited to, a maximum tensile force strength, a maximum shear force strength, or some combination thereof, etc. between two complementary magnetic structures, between a magnetic structure and a metal surface, or between other structures. In certain example implementations maxel density may affect a resulting force per unit area of a printed magnetic structure. For example, when maxels are printed with different maxel densities, the force per unit area can increase with maxel density until a particular point, and after that particular point, maxel density becomes “too dense”, and the force per unit area decreases.

As a result, a maxel density that meets one or more criteria may be determined. The one or more criteria may comprise, by way of example but not limitation, a maximum peak force per unit area ratio, wherein the peak force may correspond to a tensile force, a shear force, some combination thereof, and so forth.

In the array of FIG. 9, as discussed above, the overlapping maxels are arranged into a uniform alternating pattern of overlapping maxels. FIG. 10 shows a top view of another example two-dimensional array in which a portion of the alternating maxels indicated by the dashed line has been switched so that this portion is arranged into a complementary pattern of alternating polarities. As desired, any number, size, and shape of regions can be similarly switched so that they are arranged into a complementary pattern.

These regions of alternating maxels which are arranged into a complementary alternating pattern can themselves be configured into any desired configuration. For example, in some embodiments these regions can be treated as symbols and configured into a desired code. In this way, a set of correlated field emission structures can be constructed to contain regions which meet a criteria, such as maximum peak force per unit area, which is associated with an array such as those discussed above with uniform alternating patterns, while the set of structures still exhibit the behaviors associated with coded correlated magnetic field emission structures. As an example, FIG. 11 shows a first magnetic field emission structure having maxels which are arranged according to a first polarity pattern 1101, and a second magnetic field emission structure having maxels which are arranged according to a second polarity pattern 1102 which is complementary to the first polarity pattern 1101, where the maxels of the first magnetic field emission structure are shown having been printed left to right whereas the maxels of the second magnetic field emission structure are shown having been printed right to left. These maxels are further configured in regions that correspond to complementary Barker 4a codes.

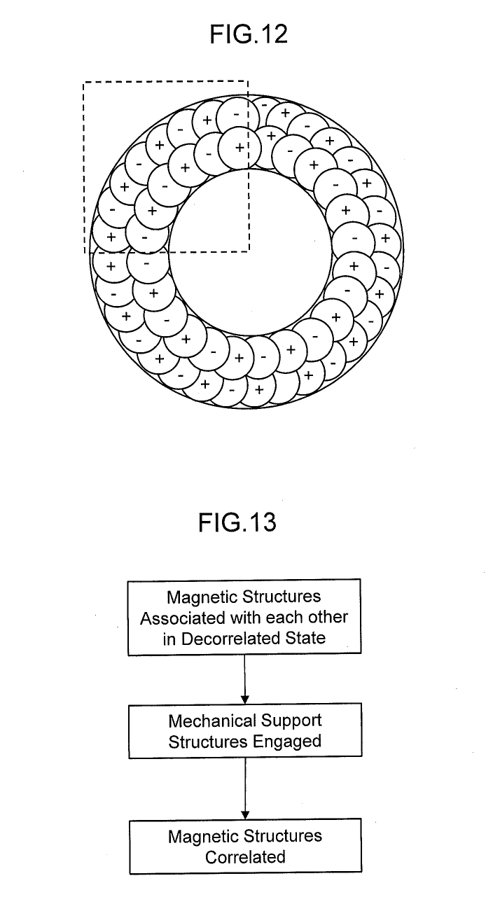

Furthermore, such regions of overlapping maxels can be used in cyclic implementations of codes, where for example the symbols may involve rows and columns as shown in FIG. 11 or alternatively may have overlapping concentric circles of overlapping maxels such as the those shown in FIG. 12 that correspond to a Barker 4 coded pattern, where a cyclic implementation of a Barker 4a code is equivalent to a cyclic implementation of a Barker 4b code.

Generally, one skilled in the art will recognize that for any given overlapping maxel pattern, the overlapping maxel pattern and a complementary overlapping maxel pattern can be used as symbols to implement codes including linear codes, cyclic codes, one dimensional codes, two dimensional codes, and so on.

In some applications, one or more sets of correlated magnetic structures can be used to secure or fasten one article to another, or one portion of a single article to another portion of the article. In certain situations, it may be desirable to augment or supplement the magnetic structures with mechanical support structures in order to keep a fastening secure under stress. As described below, the engagement and disengagement of sets of correlated magnetic structures can be augmented or supplemented by the engagement and disengagement of mechanical support structures.

FIG. 13 depicts a flowchart of a method for using a set of mechanical support structures to augment a set of correlated magnetic structures according to one aspect of the invention. First, the magnetic structures are brought into association with each other while in a decorrelated state. For example, magnetic structures which have complementary coded magnetic field emission sources arranged in a rotational (or cyclic) implementation of a Barker code can be brought together in an uncorrelated orientation that produces a relatively small amount of attract force (e.g., Barker 13), a substantially zero force (i.e., Barker 4), or a relatively small amount of repel force (e.g., Barker 7). Next, mechanical support structures that augment the magnetic structures are engaged. Finally, the magnetic structures are brought into a correlated state where they produce a relatively strong attract force.

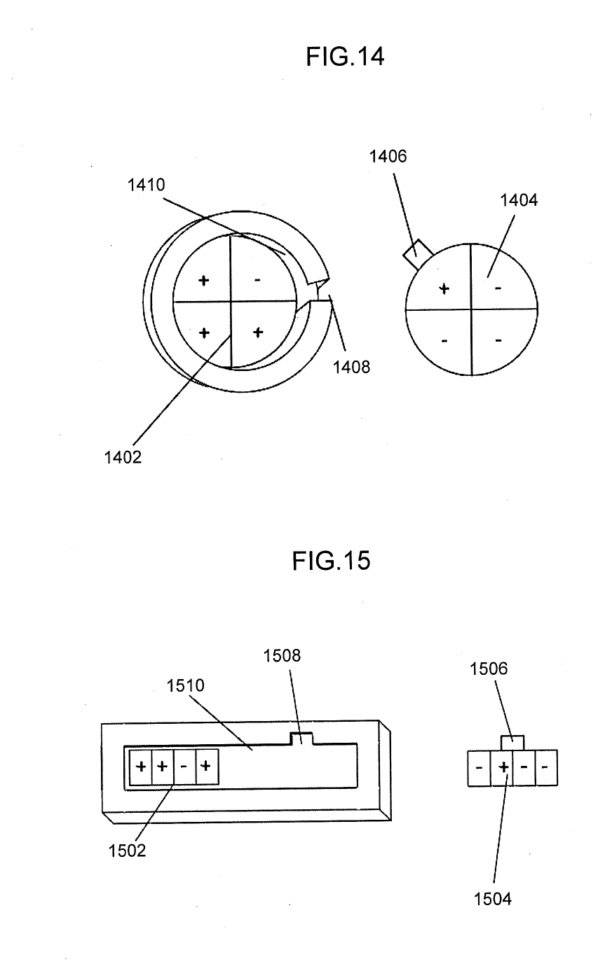

FIG. 14 depicts an example of a set of mechanically augmented correlated magnetic structures according to this aspect of the invention. In this figure, a set of magnetic structures 1402 1404 comprising cyclic arrays of complementary coded magnetic field emission sources having polarities in accordance with a Barker 4 code are augmented with mechanical support structures that include a locking tab 1406 and a slot 1408 that leads to a groove or channel 1410. When the magnetic structures 1402 1404 are brought together in a certain orientation, the locking tab 1406 can be inserted into the slot 1408 while the magnetic structures 1402 and 1404 are in a decorrelated state. The mechanical support structure can be engaged by rotating the set of magnetic structures 1402 1404 with respect to each other, which causes the locking tab 1406 to enter into and become slidably engaged with the channel 1410. As the locking tab 1406 moves along the channel 1410, the set of magnetic structures 1402 1404 can be further rotated with respect to each other until they enter into a correlated state where a peak attract force is produced.

FIG. 15 depicts another example of a set of mechanically augmented first and second magnetic structures 1502 1504 according to this aspect of the invention. This figure shows a set of magnetic structures 1502 1504 comprising linear arrays of complementary coded magnetic field emission sources having polarities in accordance with a Barker 4a code, which are also augmented with mechanical support structures that include a locking tab 1506 and a slot 1508 that leads to a groove or channel 1510. In this embodiment, the second magnetic structure 1504 can be turned over and the locking tab 1506 can be inserted into the slot 1508 such that the two structures are in a decorrelated state, which can be when the two structures are engaged but their complementary sources misaligned or when the two structures are not engaged at all (as shown). The mechanical support structures can be engaged by moving the locking tab 1506 through the slot 1508 so that it moves into and becomes slidably engaged with the channel 1510. As the locking tab 1506 moves along the channel 1510, the first and second magnetic structures 1502 1504 can move across each other until their complementary magnetic sources are aligned and they enter into a correlated state where a peak attract force is produced.

This aspect of the invention can also be accomplished using any type of mechanical augmentation, for example any type of a tab, slot, channel, groove, niche, screw, hole, aperture, or any other type of augmentation as desired.

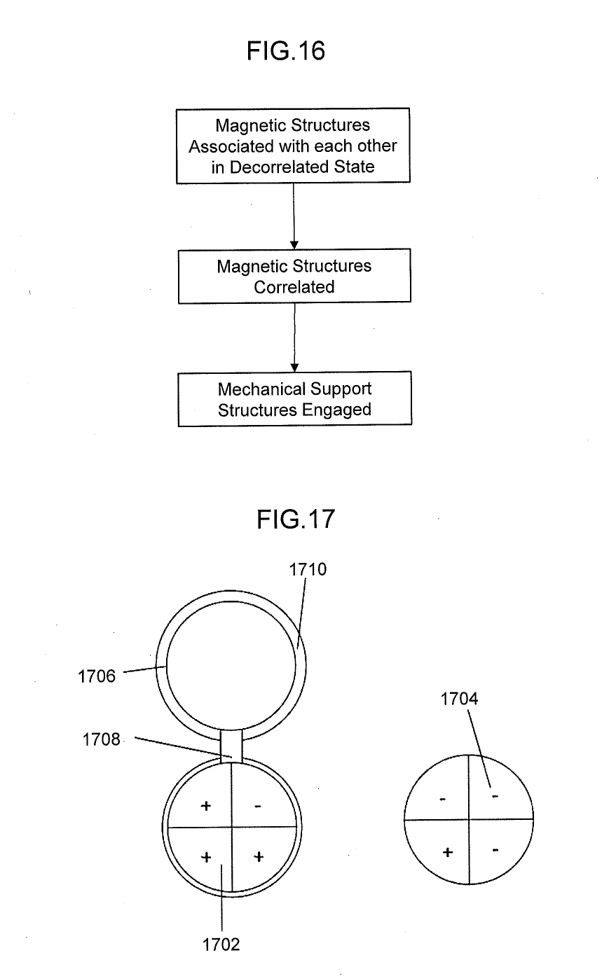

FIG. 16 depicts a flowchart for using a set of mechanically augmented correlated magnetic structures according to another aspect of the invention. As above, the magnetic structures are first associated with each other while in a decorrelated state. Next, the magnetic structures are brought into a correlated state, and then the mechanical support structures are engaged.

FIG. 17 depicts an example of a set of mechanically augmented first and second magnetic structures 1702 1704 according to this aspect of the invention. In this figure, a set of magnetic structures 1702 1704 comprises cyclic arrays of complementary coded magnetic sources having polarities in accordance with a Barker 4 code, which are augmented with mechanical support structures that include a locking flap 1706 with a hinge 1708. Optionally, the locking flap can include a snap closure 1710. The first and second magnetic structures 1702 1704 can be associated with each other in a decorrelated state by turning over the second magnetic structure 1704 and bringing them into contact with each other in an alignment position where the complementary magnetic sources are misaligned. Then one or the other magnetic structure can be rotated so that the two magnetic structures enter into a correlated state. After this, the mechanical support structures can be engaged by folding the locking flap 1706 over the magnetic support structures using the hinge 1708. The snap closure 1710 can also be engaged, for example, with a corresponding snap closure on the opposite side of magnetic structure 1704. This aspect of the invention can also be accomplished using any other type of mechanical augmentation, for example buttons, snaps, closures, fasteners, tabs, knobs, hooks, or any other type of augmentation as desired.

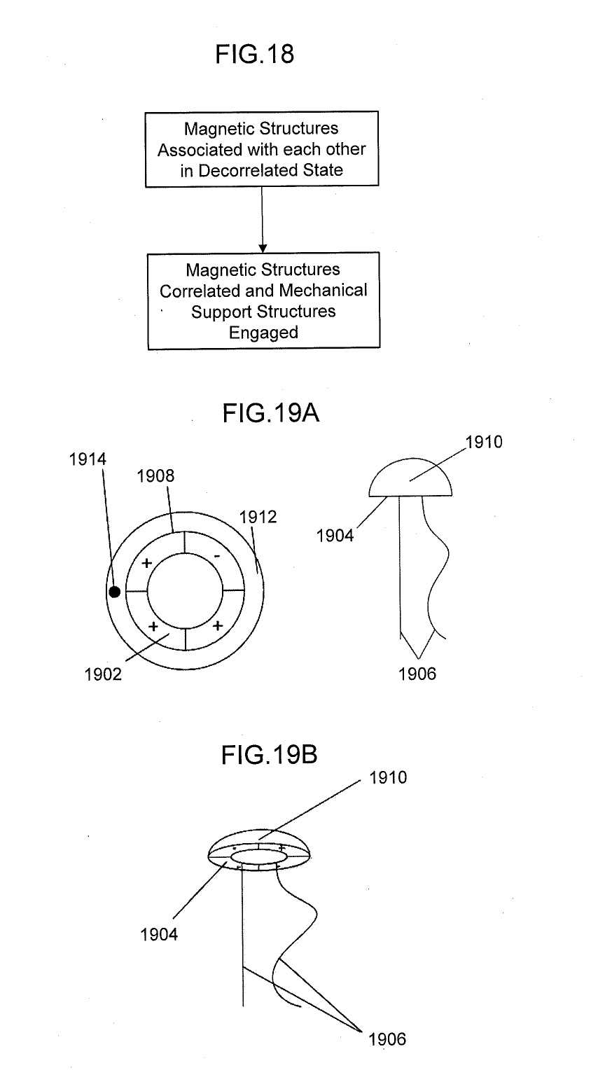

FIG. 18 depicts a flowchart for using a set of mechanically augmented correlated magnetic structures according to yet another aspect of the invention. Again, as above, the magnetic structures are associated with each other while in a decorrelated state. Next, the magnetic structures are brought into a correlated state simultaneously or substantially simultaneously with the engagement of the mechanical support structures. FIG. 19A depicts an example of a set of mechanically augmented magnetic structures 1902 1904 according to this aspect of the invention. In this example, mechanical support structures which include a cotter pin 1906 and a loop 1908 through which the cotter pin 1904 can be inserted are used to augment a set of magnetic structures 1902 1904. In this example, a first magnetic structure 1902 is located on the rim of the loop 1908, and a second magnetic structure 1904 is located on the bottom face of the head 1910 of the cotter pin 1906, as shown in the angle view of FIG. 19B. The loop 1908 can be located inside an enclosure 1912 which can have an alignment mark 1914 which can assist in aligning the cotter pin 1906 during insertion. As the cotter pin 1906 is inserted further into the loop 1908, the magnetic structures 1902 1904 can enter into a correlated state at approximately the same time as the mechanical support structures become engaged through the force of friction of the cotter pin 1906 against the loop 1908. In some embodiments, the force of friction of the cotter pin 1906 against the loop 1908 can resist engagement of the cotter pin 1906 with the loop 1908, and the peak attract force produced when the first and second magnetic structures 1902 1904 enter into a correlated magnetic state can overcome this force of friction and cause the cotter pin 1906 to become engaged with the loop 1908. This aspect of the invention can also be accomplished using any other type of mechanical augmentation, for example any type of pin, split pin, cotter pin, button, snap, loop, hook, tab, flap, or bolt as desired.

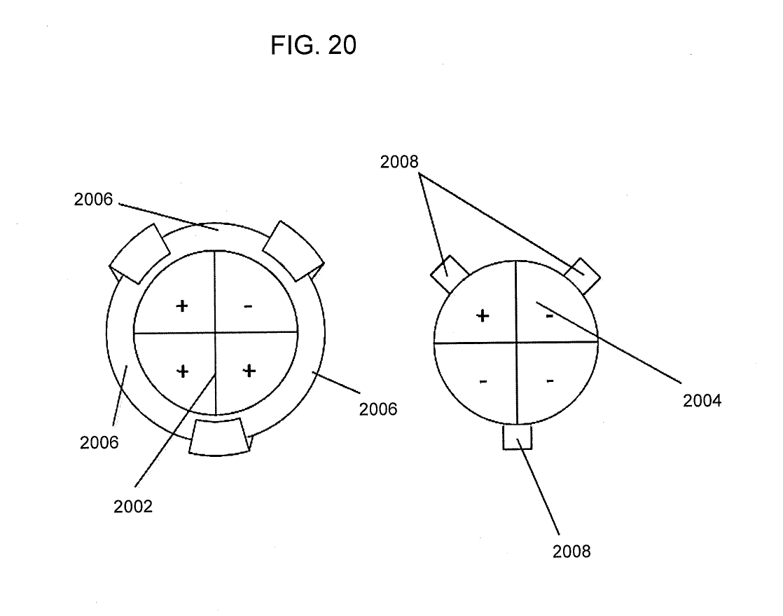

FIG. 20 depicts another example of a set of mechanically augmented magnetic structures according to this aspect of the invention. In this example, mechanical support structures which include alignment slots 2006 and alignment tabs 2008 can be arranged so that they can be engaged in only one orientation, which can correspond with the correct orientation for bringing first magnetic structure 2002 into a correlated state with second magnetic structure 2004. In some embodiments, the peak attract force produced by the correlation of first magnetic structure 2002 and second magnetic structure 2004 can cause alignment slots 2006 and alignment tabs 2008 to become engaged.

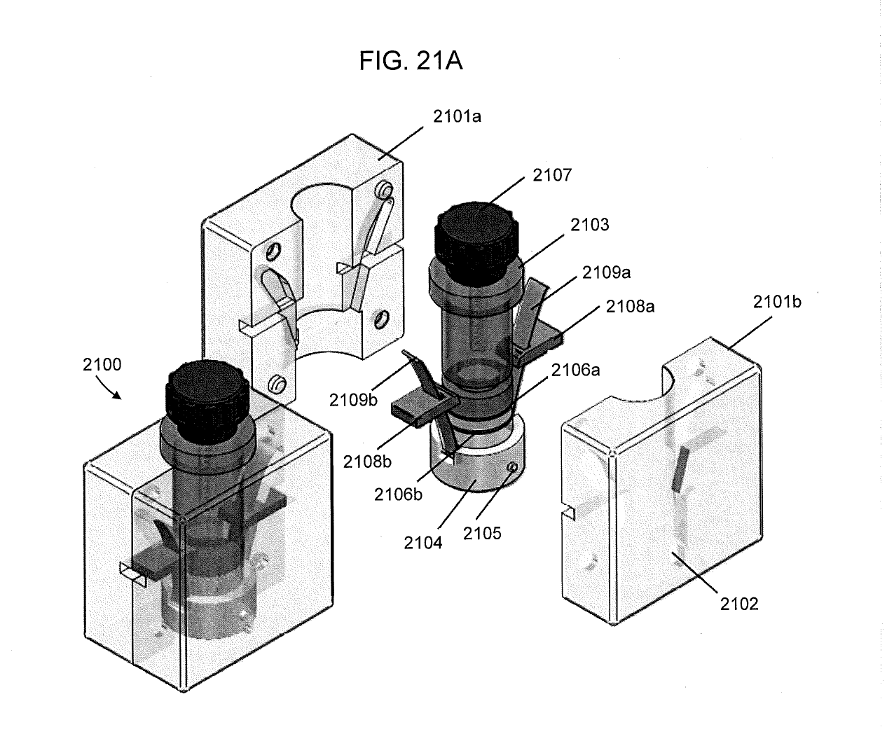

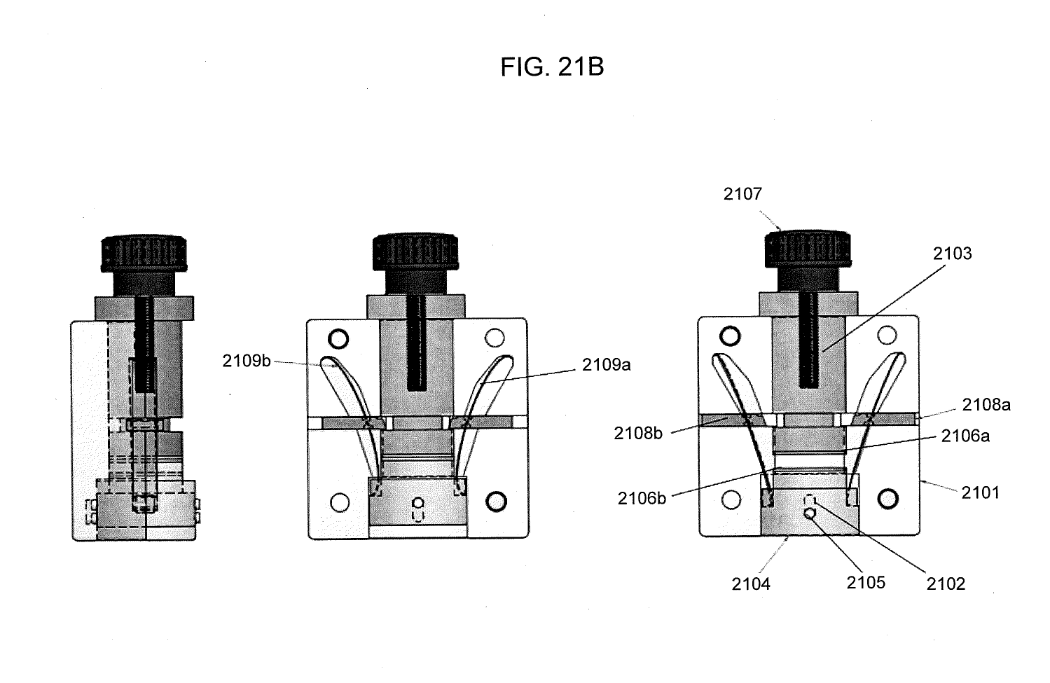

In some embodiments, the magnetic structures and mechanical support structures can be arranged so that the peak attract force produced when the magnetic structures enter into a correlated state causes the mechanical support structures to become engaged, and likewise causing the magnetic structures to decorrelate causes the mechanical support structures to become disengaged. FIGS. 21A and 21B depict an exemplary Zeus locking mechanism 2100 comprising a first and second block 2101a 2101b. The second block 2101b includes a slot 2102. An upper spool 2103 having a notch around its perimeter at a lock point fits into the first and second blocks 2101a 2101b, where it can rotate. A lower spool 2104 has a pin 2105 that fits into the slot 2102 of the second block 2101b. As such, the lower spool is constrained so it can only move up and down and cannot rotate. A first magnetic structure 2106a is affixed to the upper spool 2103 and a second magnetic structure 2106b is affixed to the lower spool 2104. A knob 2107 is attached to the upper spool 2103 enabling the upper spool 2103 to be rotated by turning of the know 2107. Two lock dogs 2108a 2108b are attached to two springs 2109a 2109b. When the knob is turned to a rotational position where the first and second magnetic structure correlate and produce a peak attract force, the lower spool 2104 will be lifted magnetically by the peak attract force thereby causing the springs to bend and force the lock dogs into the notch in the upper spool 2103. As such, correlation causes the mechanical engagement. Turning the knob such that the two magnetic structure de-correlate results in the peak attract force going away such that the lower spool 2104 drops, the spring relaxes, and the lock dogs are moved out of the notch in the upper spool. Thus, decorrelation causes the mechanical disengagement.

In other aspects of the invention, any other configuration of mechanical augmentation can be applied.

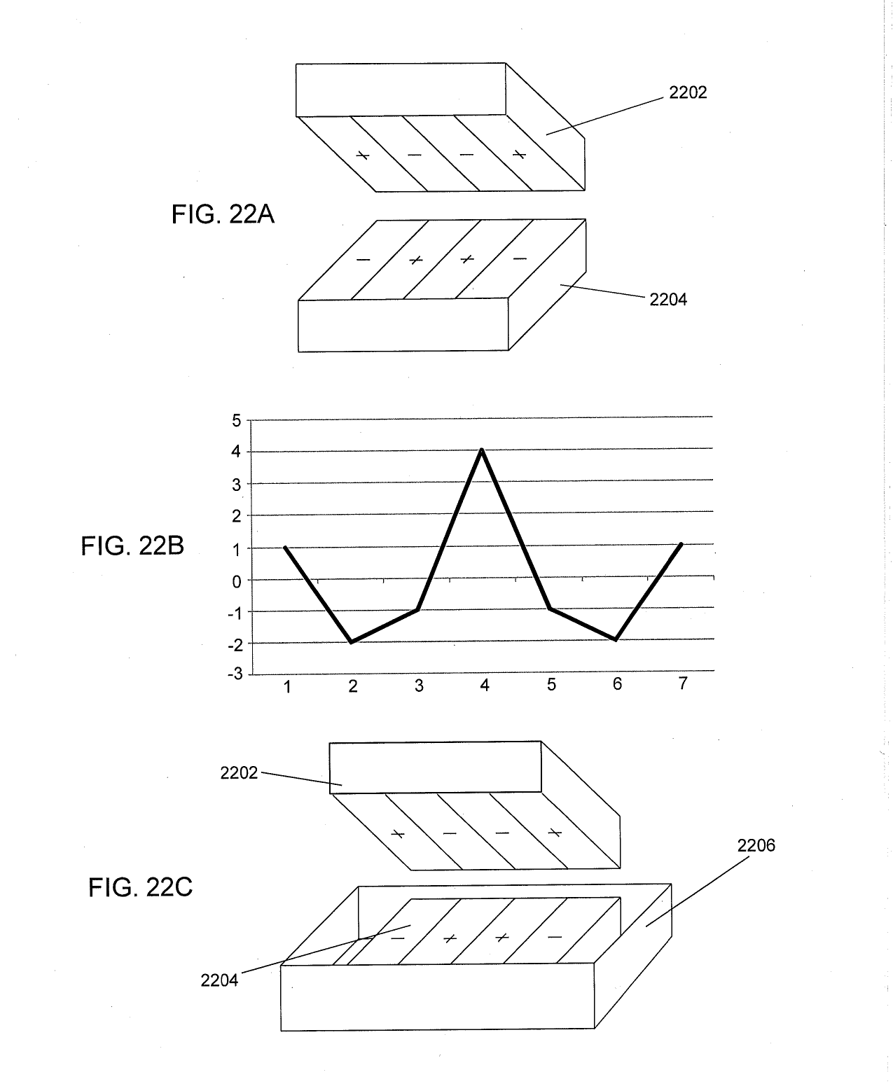

As discussed for example in U.S. Pat. No. 8,179,219, filed Jun. 2, 2009, titled “Field Emission System and Method,” which is incorporated herein by reference, sets of magnetic structures can contain magnetic sources which can be arranged according to a desired code or codes, where for each instance of the code (i.e., for each code modulo) only one alignment of the magnetic structures produces a peak force (attractive or repulsive) and other alignments produce lesser off-peak forces resulting from at least one produced attract force cancelling at least one produced repel force. The behavior of these sets of structures as they are brought into alignment with each other can be described by a correlation function. Often, portions of the correlation function exhibit undesirable characteristics, for example a ratio of peak force to maximum off-peak force that is undesirably large. However, if the movement of one or more of the magnetic structures is constrained with respect to the other magnetic structures, then the set of magnetic structures can be prevented from occupying or achieving alignment positions that correspond to the undesirable portions of the correlation function. For example, the set of magnetic structures can be constrained so that they are only able to occupy the peak position and a certain plurality of off-peak alignment positions. In this way, desirable portions of the correlation function can be isolated and used, and undesirable portions of the correlation function can be avoided. FIG. 22A shows a set of magnetic structures 2202 2204 which contain field emission sources that have been arranged according to a desired polarity pattern corresponding to an arbitrary code. The magnetic sources of a first magnetic structure 2202 have been arranged according to a code that is complementary to the code corresponding to the magnetic sources of a second magnetic structure 2204. FIG. 22B depicts the correlation function for magnetic structures 2202 and 2204. When magnetic structures 2202 and 2204 are aligned at position 4, they exert a peak attraction force on each other. The correlation function shows that the overall ratio of peak attraction force to maximum off-peak force is 2:1. FIG. 22C depicts magnetic structures 2202 2204 after being constrained by fastening magnetic structure 2204 into an enclosure 2206. Enclosure 2206 can be sized so that it only allows magnetic structures 2202 2204 to occupy alignment positions corresponding to the peak alignment position and two off-peak alignment positions on either side of the peak alignment position. When magnetic structures 2202 2204 are constrained in this way, the ratio of peak attraction force to maximum off-peak force is increased to 4:1.

This principle can be applied to magnetic structures with field emission sources arranged according to any desired code of any desired length, and in any desired configuration, for example a two-dimensional or three-dimensional configuration. For example, a set of magnetic structures which contains magnetic sources arranged according to a Barker code, for example a Barker 13 code, can be constrained in order to isolate a particular portion of the correlation function of the set of structures so that the set of magnetic structures is forced to behave in a way that is desirable for some reason. Even when the field emission sources of the set of magnetic structures are arranged in patterns that are not complementary, the structures can still be constrained in this way, for example if the correlation function between the set of magnetic structures exhibits some desirable characteristic.

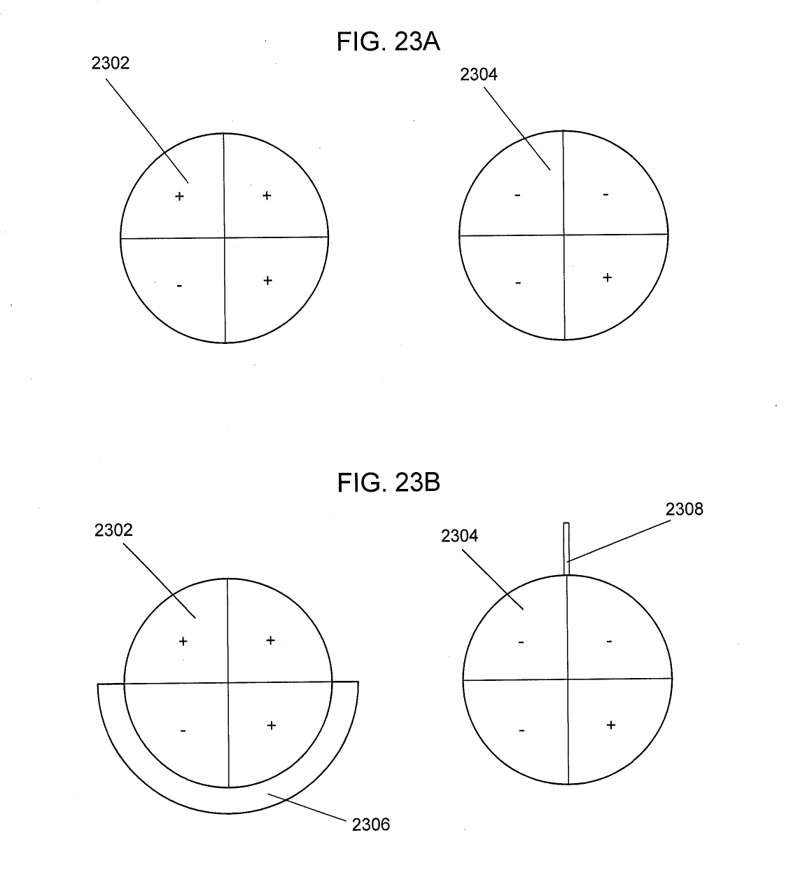

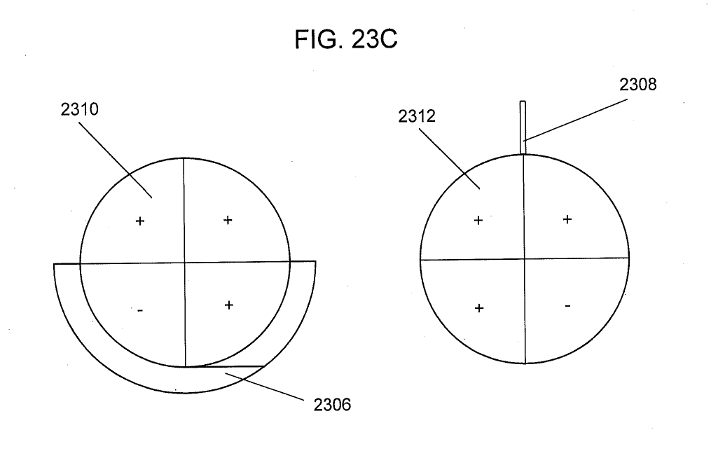

Sets of magnetic structures arranged in any configuration, for example a cyclic configuration, can be constrained to exploit desirable portions of the correlation function between the magnetic structures. FIG. 23A shows a set of magnetic structures 2302 2304 which contain field emission sources that have been arranged according a polarity pattern corresponding to a cyclic implementation of a Barker 4 code. FIG. 23B depicts magnetic structures 2302 2304 after they have been constrained to isolate desirable portions of the correlation function of code according to which their field emission sources have been arranged. In this example, the constraint consists of support structure 2306 and alignment tab 2308, which allow the structures to move from being in a peak attract force position and rotated plus or minus ninety degrees to two side lobe positions, which would have substantially zero force due to force cancellation. In other embodiments, the constraint can take any desired form, for example a tab, slot, channel, track, hook, loop, impression, niche, impression, indentation, protrusion, screw, fastener, hinge, or any combination thereof. Similarly, as depicted in FIG. 23C, a set of magnetic structures 2310 2312 containing field emission sources arranged according to the exact same polarity pattern (as opposed to complementary polarity pattern) could be used, in which case the structures would be able to move from a peak repel force position and rotated plus or minus ninety degrees to two side lobe positions that would have substantially zero force due to force cancellation.

As discussed for example in U.S. Pat. No. 8,179,219, filed Jun. 2, 2009, titled “Field Emission System and Method,” which is incorporated herein by reference, sets of magnetic structures can contain one or more magnetic sources. Each of these magnetic sources can be an individual discrete magnet, or can be an area of magnetizable material which has been magnetized or printed to form a maxel. These magnetic sources can be any shape or size, and can be arranged in any configuration as desired. Often these magnetic structures are made up of magnetic sources which have been arranged according to a polarity pattern which corresponds with a desired code. Many times the arrangement of code elements within these codes requires their corresponding magnetic sources to be placed so that a group of magnetic sources with a common polarity lie alongside or otherwise adjoin each other. In these situations, it is possible to implement each of these groups as a magnetic source region with a shape that encompasses all of the code elements corresponding to the group. These magnetic source regions can be implemented, for example, by an individual magnet in the desired shape, or by a printed maxel or group of maxels in any desired size and configuration.

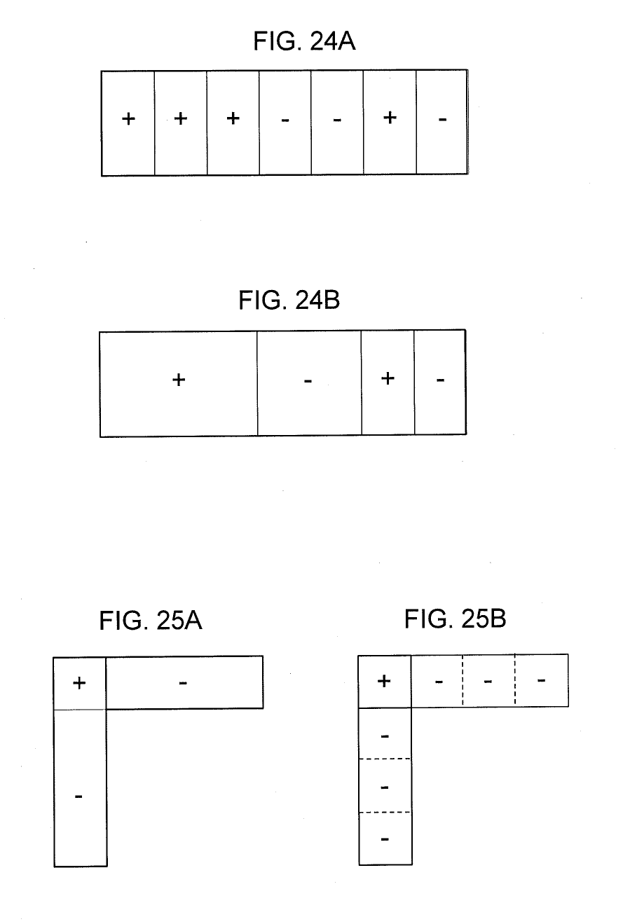

FIG. 24A shows a magnetic structure that contains magnetic sources of equal size which have been arranged in accordance with a Barker 7 code. As a result, this magnetic structure contains two groups of magnetic sources which have a common polarity that are adjacent to each other. FIG. 24B shows a magnetic structure in which these groups have been replaced by magnetic sources having different sizes that correspond to the code elements of the two groups. In this case, the Barker 7 code has been implemented as a composite structure made up of four magnetic sources of three different sizes.

Composite magnetic structures can be made up of magnetic sources of any desired size or shape, where the magnetic sources can be arranged in any desired configuration. For example, magnetic sources of different sizes and shapes can be configured to correspond with a two-dimensional code. FIG. 25A shows a composite magnetic structure in which three magnetic sources of two different sizes have been arranged in a configuration corresponding to a two-dimensional Barker 4b code (i.e., −−−+ or +++−). FIG. 25B shows the same magnetic structure overlaid with dashed lines which denote the locations of the four code elements included in the Barker 4b code.

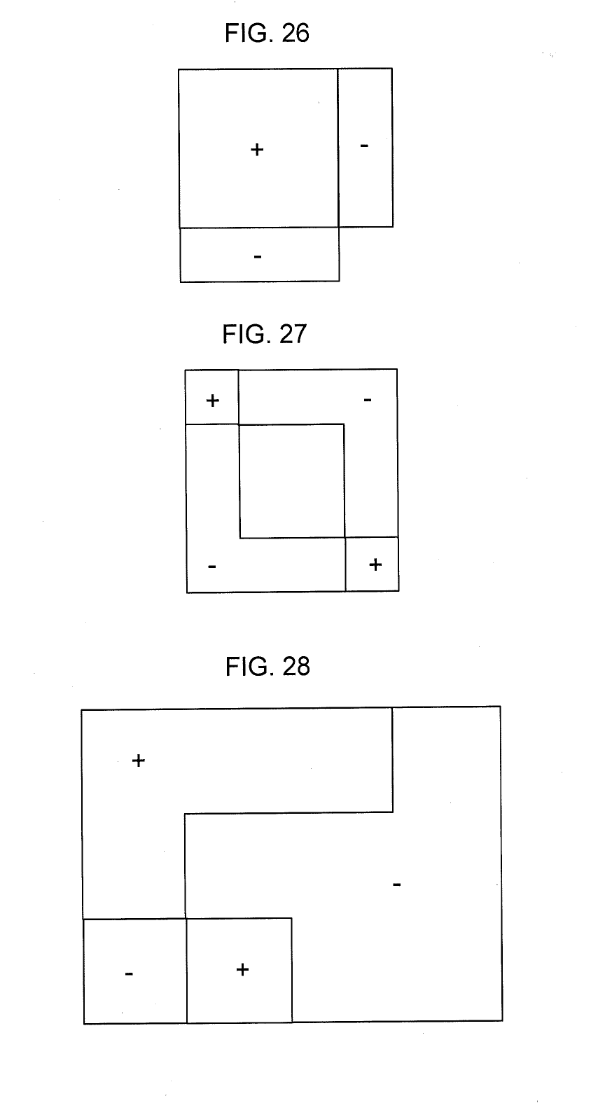

As another example, FIG. 26 shows a composite magnetic structure which includes three different magnetic sources of two different sizes that have been arranged in a configuration that implements a two dimensional Barker 4b code. FIG. 27 depicts a composite magnetic structure which includes four different magnetic sources of two different shapes and sizes arranged in a configuration corresponding to two Barker 4b codes. FIG. 28 shows a composite magnetic structure which contains four different magnetic sources of three different shapes, which if constrained to only allow left to right movement relative to a complementary structure (as depicted) the polarity pattern would have correlation behavior corresponding to a Barker 4b code (top one-third) over a Barker 4b code, over a Barker 4a code (−−+− or ++−+).

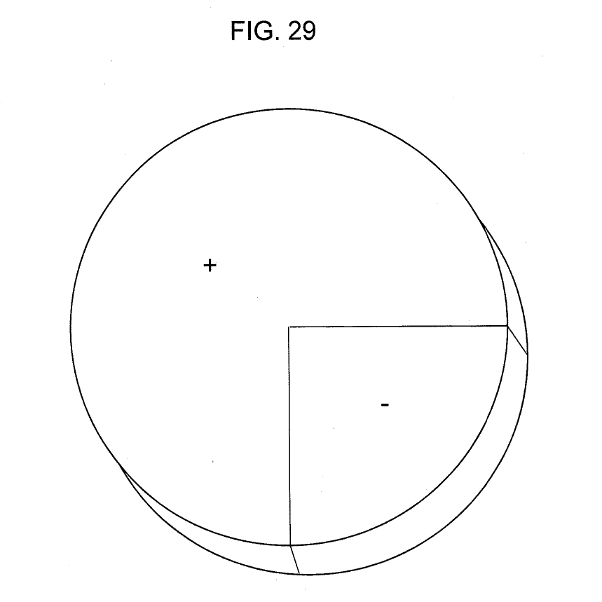

Composite structures of magnetic sources having different sizes and shapes can also be configured to correspond with, for example, cyclic or rotational codes. For example, FIG. 29 shows a composite magnetic structure which contains two magnetic sources of different shapes (i.e., three quarter circle shape and one quarter circle shape) which correspond to a cyclic Barker 4 code.

One skilled in the art will recognize that composite magnetic structures can also interact with structures having magnetic sources that are the same size. For example, a magnetic structure of same-sized magnetic sources such as shown in FIG. 24A can interact with a complementary magnetic structure that is a composite magnetic structure constructed of sources of different sizes like the composite magnetic structure of FIG. 24B.

In other aspects of the invention, any other configuration of adjustments can be applied. While particular embodiments of the invention have been described, it will be understood, however, that the invention is not limited thereto, since modifications may be made by those skilled in the art, particularly in light of the foregoing teachings.

1. A magnetic system, comprising:
a first magnetic structure comprising a first plurality of magnetic sources having a first polarity pattern;
a second magnetic structure comprising a second plurality of magnetic sources having a second polarity pattern, said first magnetic structure being movable relative to said second magnetic structure, said first and second magnetic structures being engaged and producing a peak spatial force when in a correlated state where said first and second polarity patterns are aligned, said first and second magnetic structures producing an off peak spatial force when in a decorrelated state where said first and second polarity patterns are misaligned, said off peak spatial force resulting from cancellation of at least one repel force by at least one attract force; and
at least one mechanical support structure which can be engaged to augment said peak spatial force to secure said first and second magnetic structures and which can be disengaged to allow said first and second magnetic structures to be disengaged when said first and second magnetic structures are in a decorrelated state.

2. The magnetic system of claim 1, where said first and second magnetic structures comprise linear arrays of magnetic sources.

3. The magnetic system of claim 1, where said first and second magnetic structures comprise cyclic arrays of magnetic sources.

4. The magnetic system of claim 1, wherein said first polarity pattern is complementary to said second polarity pattern such that said peak spatial force is a peak attract spatial force.

5. The magnetic system of claim 1, wherein said first polarity pattern is anti-complementary to said second polarity pattern such that said peak spatial force is a peak repel spatial force.

6. The magnetic system of claim 1, wherein said magnetic system is configured such that the first and second magnetic structures must be brought together in a first orientation corresponding to said decorrelated state prior to said at least one mechanical support structure being engaged after which said at least one mechanical support structure can be engaged while said first and second magnetic structures remain in said decorrelated state and then said first magnetic structure can be moved relative to said second magnetic structure to a second orientation corresponding to said correlated state while said at least one mechanical support structure is engaged.

7. The magnetic system of claim 6, wherein said first and second magnetic structures are brought together in said first orientation by inserting a tab into a slot.

8. The magnetic system of claim 7, wherein said at least one mechanical support structure is engaged by moving said first magnetic structure relative to said second magnetic structure to cause said tab to enter into and become slidably engaged within a channel.

9. The magnetic system of claim 6, wherein said at least one mechanical support structure comprises at least one of a tab, a slot, a channel, a groove, a niche, a screw, a hole, or an aperture.

10. The magnetic system of claim 1, wherein said at least one mechanical support structure is configured such that the first and second magnetic structures must be brought together in a first orientation corresponding to said decorrelated state and then said first magnetic structure can be moved relative to said second magnetic structure to a second orientation to achieve said correlated state prior to said at least one mechanical support structure being engaged after which said at least one mechanical support structure can be engaged.

11. The magnetic system of claim 11, wherein said at least one mechanical support structure comprises at least one of a flap, a hinge, a button, a snap, a closure, a fastener, a tab, a knob, or a hook.

12. The magnetic system of claim 1, wherein said at least one mechanical support structure is configured such that the first and second magnetic structures must be brought together in a first orientation corresponding to said decorrelated state and then said first magnetic structure can be moved relative to said second magnetic structure to a second orientation to achieve said correlated state while said at least one mechanical support structure is being engaged.

13. The magnetic system of claim 12, wherein said at least one mechanical support structures comprises at least one of a cotter pin, a loop, a split pin, cotter pin, a button, a snap, a loop, a hook, a tab, a flap, or a bolt.

14. The magnetic system of claim 1, wherein said magnetic system is configured such that said peak spatial force produced when said first and second magnetic structures enter into said correlated state causes said at least one mechanical support structure to become engaged.

15. The magnetic system of claim 14, wherein said at least one mechanical support structure comprises at least one spring and said peak spatial force causes said at least one spring to bend resulting in mechanical engagement of said at least one mechanical support structure.

16. The magnetic system of claim 1, wherein said magnetic system is configured such that causing said first and second magnetic structures to decorrelate causes the at least one mechanical support structures to become disengaged.

17. The magnetic system of claim 16, wherein said at least one mechanical support structure comprises at least one spring and said decorrelating of, said first and second magnetic structures causes said at least one spring to relax resulting in mechanical disengagement of said at least one mechanical support structure.

18. The magnetic system of claim 1, wherein said at least one mechanical support structure comprises a Zeus locking mechanism.

19. The magnetic system of claim 1, wherein said Zeus locking mechanism comprises at least one of a block, a slot, a spool, a notch, a lock point, a pin, a lock dog, or a spring.

20. The magnetic system of claim 1, wherein said first and second magnetic structures are brought together and engaged in an orientation corresponding to said correlated state.
